(19) United States
(12) Patent Application Publication
(10) Pub. No.: US 2025/0370898 A1
(43) Pub. Date: Dec. 4, 2025

(54) AI Gateway - Synthetic Monitoring

(71) Applicant: ADP, INC, Roseland, NJ (US)

(72) Inventors: Justin P Kulikowski, Roseland, NJ (US); Jason Raymond Jessico, Alpharetta, GA (US)

(73) Assignee: ADP, INC, Roseland, NJ (US)

(21) Appl. No.: 19/221,002

(22) Filed: May 28, 2025

Related U.S. Application Data
(63) Continuation of application No. PCT/US25/30227, filed on May 20, 2025.
(60) Provisional application No. 63/654,310, filed on May 31, 2024.

(51) Int. Cl. G06F 11/34; G06F 11/3668

(52) U.S. Cl. CPC G06F 11/3447; G06F 11/3692

(57) ABSTRACT

Synthetic testing systems are provided for testing AI model deployments. A test execution module may be executable by the processor to perform a synthetic test on at least one of a set of AI model deployments. The synthetic test may include a transmission of a request for an AI model to at least one of the AI model deployments, where the request includes an input prompt comprising predefined test data.

### CROSS-REFERENCE TO RELATED APPLICATIONS

This application is a continuation of international patent application PCT/US25/30227 filed May 20, 2025, which claims priority under 35 USC § 119 to U.S. provisional patent application 63/654,310 filed May 31, 2024. The entire contents of each of the above-identified applications are hereby incorporated by reference.

### TECHNICAL FIELD

This application relates to gateways and, in particular, to an Artificial Intelligence (AI) gateway.

### BACKGROUND

Present AI model providers' systems suffer from a variety of drawbacks, limitations, and disadvantages. Accordingly, there is a need for inventive systems, methods, components, and apparatuses described herein.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 is a schematic diagram of an example of an AI gateway;

FIG. 2 illustrates a flow diagram of an example of logic for authorization, consumption tracking, and routing;

FIG. 3 illustrates an example of a cached identity token;

FIGS. 4A-C illustrate an example of an entry in the appidsTable;

FIG. 5 illustrates an example of entry in the appidsTable in which the app identifier is authorized to use both PGO and PTU classes of service;

FIG. 6 illustrates a flow diagram of example logic for authorization, consumption tracking, and consumption quota enforcement;

FIG. 7 illustrates a flow diagram of example logic for authorization and consumption tracking with aggressive enforcement of quotas;

FIG. 8 illustrates example of logic for refilling quotas;

FIG. 9 is a flow diagram of example logic for creating and selecting routes;

FIGS. 10A-L illustrate an example of a supportedRoutes entry;

FIG. 11 illustrates an example route in the routes table;

FIG. 12 illustrates an example of a provider entry in the provider table;

FIG. 13 illustrates an example of weighted routing;

FIG. 14 illustrates an example of preferred target routing;

FIG. 15 is a flow diagram of example logic for preferred target routing using a permissive enforcement of the quota system;

FIG. 16 illustrates an example of route in which one of the AI model deployments has prepaid tokens;

FIG. 17 illustrates an example architecture for the AI gateway that includes a metadata bus;

FIG. 18 illustrates an example of a system 1800 that provides synthetic testing of the AI model deployments; and

FIG. 19 illustrates an example where the AI gateway 100 is included in a memory.

### DETAILED DESCRIPTION

In one example, an AI gateway is provided that includes a processor and a request handler. The request handler is executable by the processor to receive an AI service request for an AI model from a client. The request handler is further executable by the processor to proxy the AI service request to an AI model deployment, where the request handler is executable by the processor to select the AI model deployment from a plurality of AI model deployments based on a quality of service.

One technical advantage of the systems and methods described below may be that the quality of service when servicing AI service requests may be controlled. For example, some AI model deployments may perform faster than others, and the AI gateway may control which AI model deployments receive the AI service requests to maintain a level of performance. Another technical advantage of the systems and methods described below may be that the AI gateway may monitor the performance of the AI model deployments and adjust routing of the AI service requests accordingly.

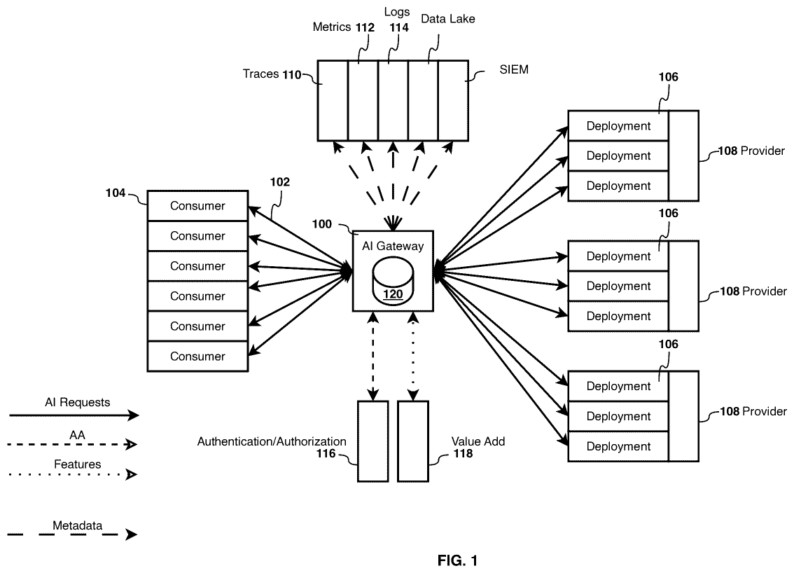

FIG. 1 is a schematic diagram of an example of an AI gateway 100 configured to route AI service requests 102 from clients 104 to AI model deployments 106, which are AI services. The clients 104 are consumers of the AI services. There may be one or more AI model deployments 106. Each provider 108 may host a corresponding set of the AI model deployments 106. The AI gateway 100 may route the AI service requests 102 to the AI model deployments 106 of one or more of the providers 108.

During operation of the AI gateway 100, the clients 104 are funneled towards a single logical service entry point of the AI gateway 100, which in turn, is logically connected to one or more sets of the AI model deployments 106 hosted by one or more of the providers 108. This initial arrangement may reduce the toil and complexity of maintaining many-to-many relationships between clients 104 and the AI services. From its privileged point in the middle of transactions, the AI gateway 100 may add services that provide data, such as traces 110, metrics 112, and logs 114. The AI gateway 100 may do this while providing enterprise logic such as authentication and/or authorization logic 116. As clients 104 encounter new scenarios that require AI functionality, these may be developed as value-add features 118 of the AI gateway 100 and, therefore, potentially delivered to all clients 104 automatically, further increasing the velocity of client development.

The AI gateway 100 may present stable interface contracts towards the clients 104. In some examples, these stable interface contracts or APIs may be designed to be as similar to the underlying AI service as possible to allow developers to onboard to the AI service quickly. In other words, the API exposed by an AI service provider to access its AI service may be the same or similar to the API exposed by the AI gateway to access the AI service. This may be considered an unexpected approach because the AI gateway 100 providing access to a variety of the AI model deployments 106 might benefit to exposing a new API that may be common to the AI model deployments 106. Alternatively, or in addition, data emitted by the AI gateway to back-end AI services may be normalized to present consistent, high context information about how the underlying AI services are being used by clients of the AI gateway.

To successfully use AI services safely, efficiently, and at scale, the AI gateway 100 may provide and/or enable one or more of the following features in addition to providing external and internal AI services: Resource Sharing, Governance, Availability, Sustainability, and Accelerated Adoption.

### Resource Sharing

The AI gateway 100 may enable resource sharing across different classes of service. The AI providers 108 typically offer their services in two classes. The first class of service is a dedicated deployment model, where resources are provisioned specifically for consumers and guaranteed to meet specified service levels. The second class of service is a shared deployment model, where resources provide identical features, but at “best effort” service level agreements (SLAs). A “best effort” service level agreement means the provider 108 agrees to attempt to meet service standards but doesn't guarantee specific performance metrics such as uptime or speed. AI based applications executing at the clients 104 may require access to one or more of these service classes when accessing the AI model deployments 106.

In some examples, the AI gateway 100 may enable resource sharing by providing shared access to provisioned throughput units (PTU). A provisioned throughput offering is a model deployment type where an amount of throughput required for an AI model deployment may be specified. PTU deployments may be exceptionally expensive. By granting multiple applications access to the same underlying pool of expensive AI resources, the AI gateway 100 may leverage its scale to offer premium performance to smaller applications.

Alternatively, or in addition, the AI gateway 100 may enable resource sharing by providing consolidated Pay as You Go (PGO) access. PGO deployments may be appropriate for many applications except that many PGO deployments have a relatively reduced SLA. By placing many PGO AI services behind a single entry point, the AI gateway 100 may offer PTU like performance by silently routing around poorly performing AI service(s).

### Governance

Funneling the AI service requests 102 through one logical entry point enables the AI gateway 100 to consolidate access control and/or understand applications' consumption of AI services. For example, to provide access control, the AI gateway 100 may apply a standard authentication and a novel authorization mechanism and quickly to the AI service requests 102 made through the AI gateway 100. Alternatively, or in addition, the AI gateway 100 may monitor consumption by being application layer aware so that more than request rate and quantity may be monitored. Centrally monitoring a set of attributes about AI consumption, as opposed to per-application implementations, allows for consistent presentation and understanding of the consumption of AI services.

### Availability

The AI gateway 100 may be scalable. The AI gateway 100 may transparently add capacity to meet unexpected demand so that service may be maintained at high levels of capacity. Similarly, the AI gateway 100 may be able to integrate with, and pass through, newly provisioned downstream AI capacity.

The AI gateway 100 may be fault tolerant. The AI gateway 100 may be deployed in a manner where there are no internal single points of failure and, in addition, no likely external logical points of failure that deny service. For the former, N+1 instances of the AI gateway 100 with disambiguated control & data planes may be deployed. For the latter, the AI gateway 100 may be deployed across different providers and in different regions.

What transpires in the AI gateway 100 may be transparent and observable. For example, during operation, the AI gateway may emit enough signals to demonstrate, in the absence of any user feedback, that the AI gateway 100 is operating as expected. Opaque services lend themselves to being the first to be blamed and the last to be exonerated in any outage.

### Accelerated Adoption

Management and market pressures continue to stress speed in delivering AI-based features. The AI gateway 100 may reduce time-to-market. For example, the platform may be able to rapidly get to a minimum viable product in serving at least one consumer. New features from underlying AI service providers may be exposed quickly to avoid end runs around the platform.

The AI gateway 100 may aid in adoption by providing consistency. The API through which consumers use the AI gateway 100 may be stable over time so that the AI consumers spend time developing application capabilities and not refactoring code to a new API that offers no new value. The AI gateway 100 may be built with, and rely on, infrastructure solutions that are proven in the market and generally evoke feelings of goodwill amongst the potential consumers. The AI gateway 100 may add value to the AI service requests 102 so that AI consumers may take advantage of capabilities that other AI consumers have developed for the AI gateway 100 during their application creation.

### Per Client LLM Consumption and Quality of Service (QOS)

Per identity Quality of service (QOS) may be delivered by the AI gateway 100 through the combination of identity-based authorization and intelligent route building. Identity-based authorization may be to classes of service offered by the providers 108. Alternatively, or in addition, identity-based authorization may be to token-based consumption quotas for each class of service. Per identity Quality of service (QOS) may be delivered by the AI gateway 100 through the combination of identity-based authorization and intelligent route building. Identity-based authorization may be to classes of serviced offered by the providers 108. Alternatively, or in addition, identity-based authorization may be to token-based consumption quotas for each class of service. The AI gateway 100 may rely on a database 120 for authorization and/or intelligent route building.

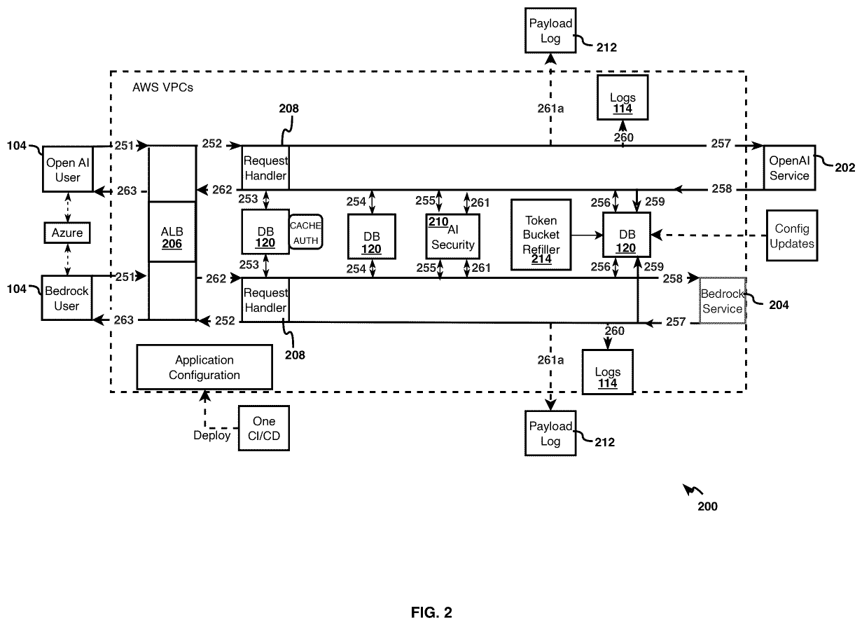

FIG. 2 illustrates a flow diagram of an example of authorization, consumption tracking, and routing logic 200. In the illustrated example, a first one of the clients 104 is a user of an OPENAI (a registered mark of OpenAI, Inc.) branded AI service 202, and a second one of the clients 104 is a user of an AMAZON BEDROCK (a registered mark of Amazon Technologies, Inc.) branded AI service 204. However, in other examples, the clients 104 may access additional, fewer, and/or different AI services 202 and 204. The AI gateway 100 is configured to receive AI service requests 102 from the clients 104. In the example shown in FIG. 2, the AI gateway 100 is implemented on an AWS (a registered mark of Amazon Technologies, Inc.) branded platform in a virtual private cloud (VPC). The AI gateway 100 may be implemented on any cloud platform, with or without a VPC. In some examples, the AI gateway 100 may be implemented on a non-cloud platform, such as in on-premises environment.

For both types of clients 104 in the illustrated example, the identity of the application (appid) is provided by the clients 104 in the AI service request 102. The identity may be an API key, an oauth bearer token, or any other identifier. Here, the clients obtain an Azure appid and use the appid to create a bearer token. The bearer token is provided with the AI service requests 102 to the AI gateway 100. To obtain an Azure appid, the current public certificates may be obtained from Azure Active Directory (AD), the presented bearer token may be decoded and validated, and the appid may be extracted therefrom.

The operations involved in handling the AI service request 102 for the OPENAI branded AI service 202 and the AMAZON BEDROCK branded AI service 204 are the same in the example illustrated in FIG. 2. The client 104 sends the AI service request 102 to an application load balancer 206 of the AI gateway 100. The application load balancer 206 receives (251) the AI service request 102 and proxies (252) the AI service request 102 to a request handler 208 of the AI gateway 100. As described below, the request handler 208 may distribute requests for specific models evenly across, or based on any distribution algorithm to, the providers 108 that are available. The code in the request handler 208 in the illustrated example is the same for both types of clients 104. In some examples, the code in the request handler 208 may be provider 108 agnostic. Alternatively, or in addition, the code in the request handler 208 may include code that is specific to one or more of the providers 108.

The request handler 208 may be implemented on, for example, a serverless compute service, such as AWS Lambda. The request handler 208 may authorize (253) the AI service request 102 and cache the bearer token if the bearer token is not yet cached. The bearer token may be cached in the database 120, for example, with an expiration time. To authorize (253) the AI service request 102, the identity is obtained from the AI service request 102 and validated. For example, the request handler 208 may validate a bearer token with Azure Active Directory. In the illustrated example, the identity is established from the AI service request 102. The request handler 208 may use the current state of the identity to determine if the AI service request 102 is authorized. For example, the AI service request 102 may be authorized if: the identity has access to the requested class of service; and the identity has remaining tokens in the current interval for the use of that class of service. As explained further below in more detail, the request handler 208 may locate (254) an available route for the provider requested in the AI service request 102.

In some examples, the request handler 208 may invoke (255) an AI security module 210 to perform a security check on content of the AI service request 102. For example, the request handler 208 may invoke CALYPSO AI's scan API to assess the content. If the security check fails, the request handler 208 may reject the AI service request 102. The request handler 208 may log the result of the security check. Another example of the AI security module 210 may include AMAZON BEDROCK Guardrails branded AI security service.

The request handler 208 may check (256) a token bucket of the appid for the requested provider, where the token bucket is stored in the database 120. If the token bucket is empty, then the AI service request 102 may be rejected. Alternatively, if not rejected, the request handler 208 may send (257) the AI service request 102 or a modification thereof to the OPENAI branded service 202 or the AMAZON BEDROCK branded AI service 204 depending on the route located (254) in the database 120. As a result, the request handler 208 receives (258) a response from the OPENAI branded service 202 or the AMAZON BEDROCK branded AI service 204.

The request handler 208 may decrement (259) the token bucket of the appid for the requested provider in the database 120. In some examples, the request handler 208 may write (260) to the logs 114 to reflect the consumption. For example, the request handler 208 may write consumption information to AMAZON's CloudWatch logs.

In some examples, the request handler 208 may invoke (261) the AI security module 210 to perform a security check on the response received from the AI service 202 or 204. For example, the request handler 208 may invoke CALYPSO AI's scan API to assess the response. If the security check fails, the request handler 208 may reject the AI service request 102. If payload logging is enabled for the appid, for example, the input and/or output of the AI service request 102 may be written (261a) by the request handler 208 to a payload log 212, such as a client provided S3 bucket on AWS.

The operations may end by the AI service request 102 providing (262) the response received from the OPENAI branded service 202 or the AMAZON BEDROCK branded AI service 204 to the application load balancer 206, which forwards (263) the response to the client 104. All chat completions and embeddings for deployments and models that are available to the AWS account in the illustrated example may be made available to the client 104.

### Background Process

A token bucket refiller 214 regularly refills the token bucket in the database 120 for every app. For example, the token bucket refiller 214 may be implemented on, for example, a serverless compute service, such as AWS Lamda. The token bucket refiller 214 may be executed on an EventBridge schedule or any other type of scheduler. The token bucket refiller 214 may be executed every minute, every other minute, or at any other suitable interval or timeframe. The rate at a which the token bucket refiller 214 refills the token bucket may depend on the configuration of the provider and/or service. For example, the rate at which the token bucket is refilled for the OPENAI branded AI service 202 versus the AMAZON BEDROCK AI service 204 may be described in the appid item in the database 120. For example, an appid of my_appid may be allocated at a rate of 500 tokens per minute of gpt-35-16k and 1000 tokens per minute of AMAZON BEDROCK. In some examples, the database 120 may include a DynamoDB that is configured to refill the token buckets per appid per AI service 202 and 204, on a sliding window rate.

The token bucket refiller 214 and/or other background process may populate each labeled route with available providers as explained further below. For example, each OpenAI labeled route may be populated with available providers.

Alternatively, or in addition, the token bucket refiller 214 and/or other background process may expire out cached bearer tokens from the database 120 no earlier than one hour—or any other time period—after the bearer tokens were cached.

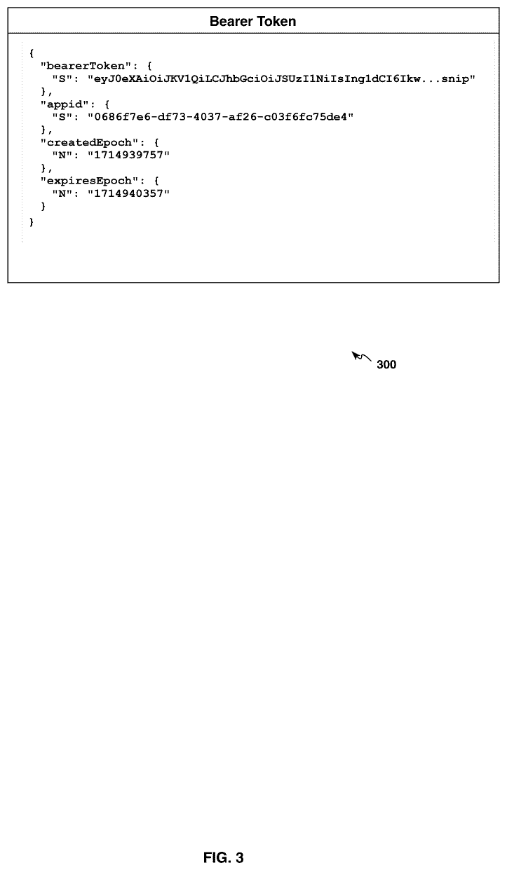

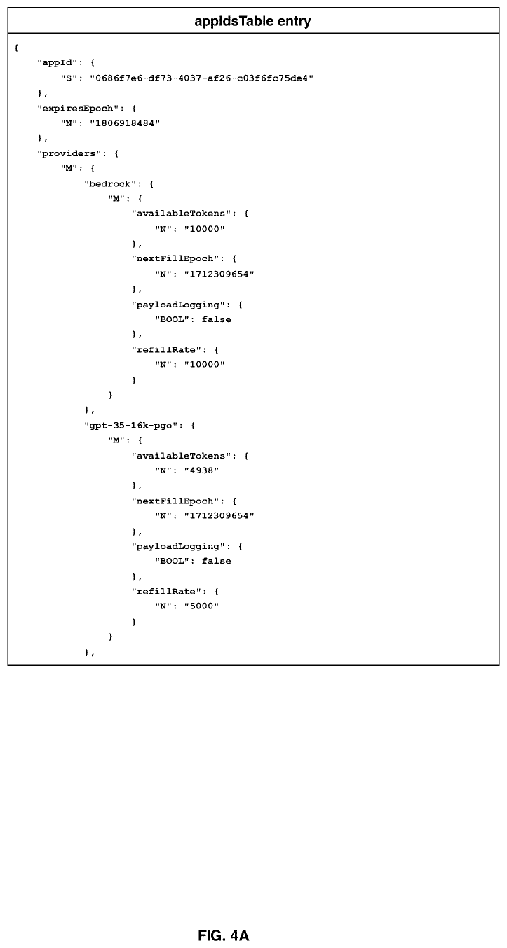

FIG. 3 illustrates an example of a cached identity token 300, an app identifier 302. In the illustrated example, the app identifier 302 is a bearer token that may be cached in the database 120. The app identifier 302 may be any value or data structure that identifies an application, a user, a group, and/or a customer for authorization purposes.

In some examples, the database 120 may be configured to remove app identifiers after the app identifiers expire. For example, if the database 120 is DynamoDB, then DynamoDB may be configured to remove the app identifier 302 when a field, such as expiresEpoch, indicates the app identifier 302 has expired. In this example, removing the app identifier 302, such as a bearer token, invalidates the cached bearer token. The app identifier 302 may be invalided using any other type of process. For example, the expiration time, such as the expiresEpoch field, of the app identifier 302 may be checked every time the app identifier 302 is retrieved from the database 120. As another example, the token bucket refiller 214 may remove the app identifier 302 from the database 120 when the app identifier 302 expires, as noted above. The format of the time indicated in an “expiresEpoch” field may be Unix epoch, which is the number of seconds that have elapsed since Jan. 1, 1970 (midnight UTC/GMT), not counting leap seconds (in ISO 8601:1970-01-01T00:00:00Z).

### Authorization

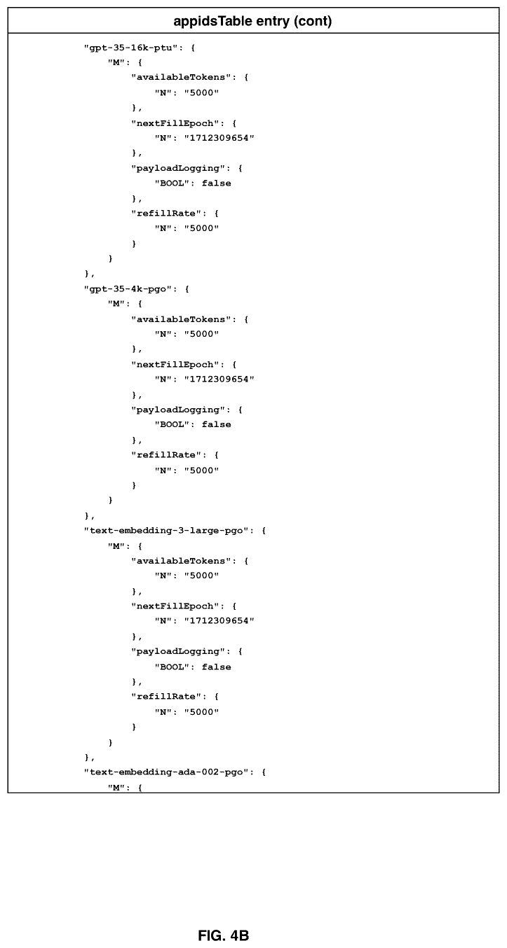

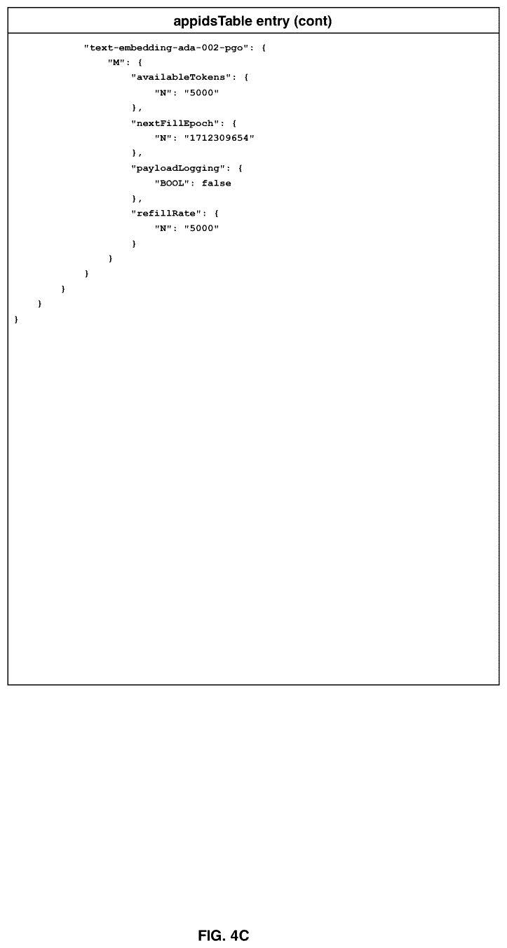

Each app identifier 302, for example, an Azure appid, may have an entry in an appidsTable of the database 120. The entry in the appidsTable may specify the AI model deployments 106 to which the app identifier 302 has access and the number of tokens permitted for each of those AI model deployments 106 to which the app identifier 302 has access. In some examples, the entry itself may have an expiration time, such as the number of seconds since epoch after which the entry will expire. When the entry in the appidsTable or the app identifier 302 expires, access to the AI services via the AI gateway 100 is revoked. FIGS. 4A-C illustrate an example of an entry in the appidsTable.

### Request Rate Limiting

In some examples, the AI gateway 100 may limit consumption by providing basic enforcement of a rate determined as total requests per unit of time. Alternatively, or in addition, the AI gateway 100 may limit consumption by providing basic enforcement of a rate determined as total requests per unit of time per app identifier 302.

### Consumption Quotas

Consumption per app identifier 302 may be limited based on a token bucket allocated to each app identifier 302. Alternatively, or in addition, consumption per app identifier 302 may be based on token rate limiting. For example, each app identifier 302 may be given a token bucket that is reduced on every successful request and refilled at a regular interval by a background process. The clients 104 making a request that cannot be fulfilled may be given a Retry-After seconds calculated from the next refill time associated with the token bucket allocated to the app identifier 302. Token buckets may be specific per app identifier 302 per model. The token bucket may indicate, for example, the number of large language model (LLM) tokens available to the app identifier 302. The token bucket may be stored in the database 120. The logic for enforcing consumption quotas may include logic that handles checking and updating the token bucket for each AI service request 102 and logic that refills the token bucket for every app identifier 302.

Like the example appidsTable entry shown in FIGS. 4A-C, each app identifier 302 may have a consumption token bucket for each AI model deployment 106. Note that any one AI model may have multiple AI model deployments, where the deployments vary in class of service.

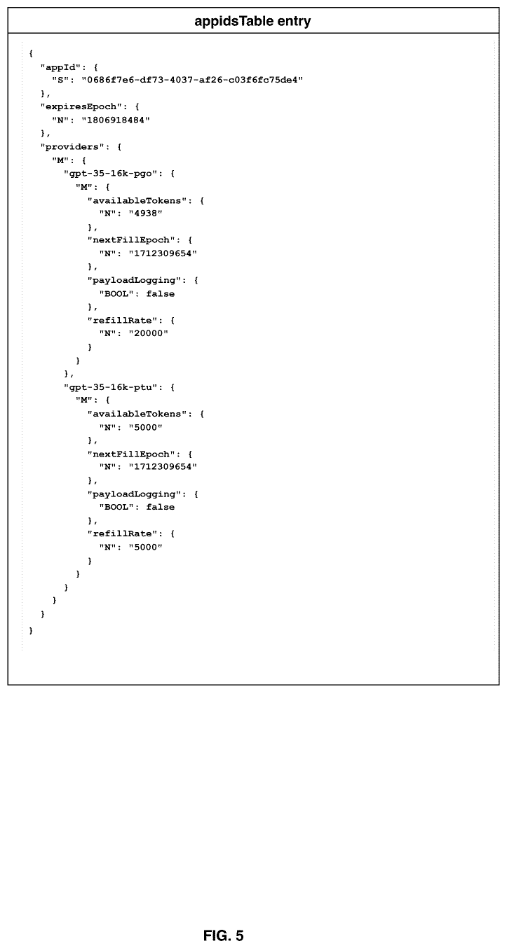

FIG. 5 illustrates an example of entry in the appidsTable in which the app identifier 302 is authorized to use both PGO and PTU classes of service for the AI model gpt-35-16k. Nevertheless, in the example, the token bucket for the PTU deployment has a lower token refill rate than the PGO deployment. In the example shown in FIG. 5, the app identifier 302 of “0686f7e6-df73-4037-af26-c03f6fc75de4” may use both a “best effort” class of service for gpt-35-16k-pgo as well as a “high performance” class of service for gpt-35-16k-ptu because there is an entry for each. In such a manner, the AI gateway 100 may provide varying quality of service to the clients 104.

The AI service request 102 with the app identifier 302 of “0686f7e6-df73-4037-af26-c03f6fc75de4” for gpt-35-16k-pgo would be denied if the “available Tokens” property of the “gpt-35-16k-pgo” entry were zero indicating there are no available Tokens for this the app identifier 302. In addition, this app identifier 302 may not successfully request another class of service called gpt-35-4k-pgo that may be available to other identities that have in their corresponding entity data structure, for example, a “gpt-35-4k-pgo” entry with a non-zero “available Tokens” property. Despite not being able to request a “best effort” class of service for gpt-35-16k-pgo in such a scenario, the AI service request 102 may be forwarded to a “high performance” class of service for gpt-35-16k-ptu if this entity has available tokens for gpt-35-16k-ptu.

The “available Tokens” property may be increased by the amount specified in a “refillRate” property at a given refill interval. The refillRate may be one minute or any other suitable time interval. Accordingly, the available tokens property may also be considered to be the number of tokens that remain available for use by clients 104 during a period before the next refill.

As noted above, after the AI service request 102 is fulfilled by a provider via one of the AI model deployments 106, the request handler 208 may decrement the number of tokens the request has consumed from the identity's allocation by updating the availableTokens property of the entity data structure for the identity in the appidsTable.

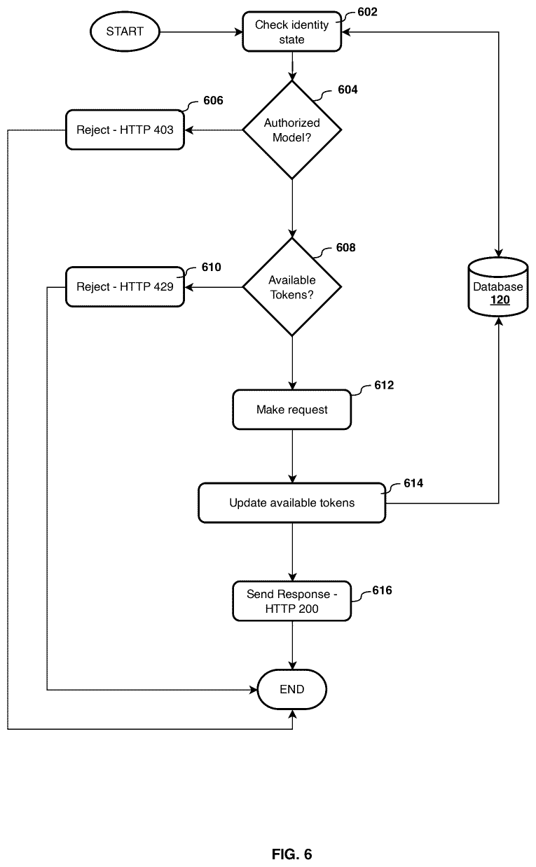

FIG. 6 illustrates a flow diagram of example logic for authorization, consumption tracking, and quota system enforcement. The operations shown in FIG. 6 are for a permissive enforcement of a quota system. The permissive enforcement of a quota system may be the default behavior in some examples.

Operations may begin by checking 602 the state of the identity associated with the AI service request 102 received by the request handler 208. For example, the request handler 208 may search the database 120 for an entry in the appidsTable for the app identifier 302. The entry may represent the current state of the app identifier 302. As described above, the entry may include the currently available tokens for the AI model deployment 106 requested in the AI service request 102.

Next, the AI service request 102 may be authorized 604. For example, if there is no entry in the appidsTable for the app identifier 302, or if there is no configuration in the entry for the AI model deployment 106 requested, then operations may end by rejecting 606 the AI service request 102 by, for example, returning an HTTP error to the client 104, such as an HTTP 403 Forbidden error.

Alternatively, if the AI service request 102 is authorized, then the available tokens may be checked 608. For example, if the availableTokens value in the entry associated with the app identifier 302 for the AI model deployment 106 is less than zero, then then operations may end by rejecting 610 the AI service request 102 by, for example, returning an HTTP error to the client 104, such as an HTTP 429 Too Many Requests error. In some examples, the HTTP 429 error may be returned with an estimate in seconds for when the next bucket refill will occur. The AI model deployments 106 having no remaining tokens in a current interval may be excluded from being selected. On the other hand, if the availableTokens is greater than zero, then the request may be made 612 to the provider 108.

After the request has been processed by the provider 108, the available tokens may be updated 614. For example, the total tokens of consumption may be extracted from the response received from the provider 108, and the token bucket for the app identifier 302 for the AI model deployment 106 is reduced by the token consumption quantity.

Operations may end by, for example, returning 616 the response from provider 108 to the client 104.

The logic for the permissive enforcement of quotas described in connection with FIG. 6 may be a soft or inexact cap in some scenarios. For example, if the available Tokens value is greater than zero but less than how many tokens will actually be used in the request, the request may still be permitted. As an example, if the available Tokens value is 10 and the request will take 5,000 tokens to complete, the request may still be permitted. In another example of a soft or inexact cap, if the amount of requests that are in flight will zero out the token bucket, new requests will be permitted. Requests that are in flight include requests that are currently being processed by the provider 108.

The AI gateway 100 may also be capable of a more precise and aggressive quota system where an identity's quota is decremented prior to making the underlying request and then again after the response is received. This limits how far a quota can go negative as well as closes an enforcement gap that can occur when there are many in flight requests in the same period.

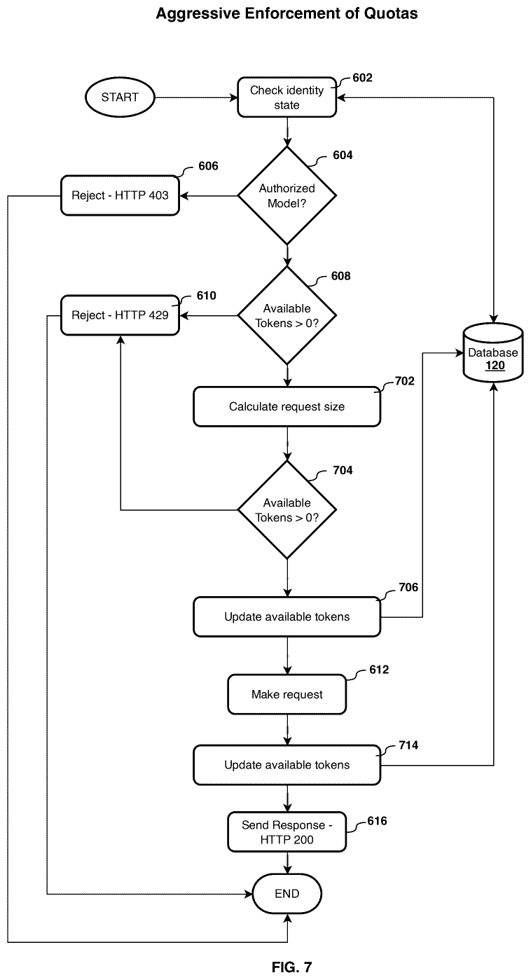

FIG. 7 illustrates a flow diagram of example logic for authorization and consumption tracking with aggressive enforcement of quotas. The example logic for aggressive enforcement of quotas may be the same as the logic for the permissive enforcement of quotas with a few changes. First, after checking 608 whether there are available tokens and before making 612 the request to the provider 108, the request size is calculated 702. The request size may be a token size. The token size may be determined by any type of token estimator. Examples of the token estimator may include a module that does a simple character count, a module that does an estimation based on the number of bytes in the request, a library that determines an average value of prior requests from the client 104, and a module that performs any method for calculating token size now known or later discovered.

Next, the available tokens may be checked 704 again but this time taking the estimated number of tokens into account. For example, the estimated number of tokens likely to be required is subtracted from the availableTokens value in the entry associated with the app identifier 302 for the AI model deployment 106, and if the resulting value is less than zero, then then operations may end by rejecting 610 the AI service request 102 by, for example, returning an HTTP error to the client 104. Alternatively, the availableTokens value is updated in the database 120 by reducing by the available Tokens value in the entry in the database 120 by the estimated number of tokens.

After updating 706 the available tokens, the request to the provider 108 may be made 612. After the request has been processed by the provider 108, the available tokens may be updated 714 again. For example, the total tokens of consumption may be extracted from the response received from the provider 108, and the token bucket for the app identifier 302 for the AI model deployment 106 may be appropriately reduced or increased by the difference between the token consumption quantity and the previously estimated number of tokens.

Operations may end by, for example, returning 616 the response from the provider 108 to the client 104.

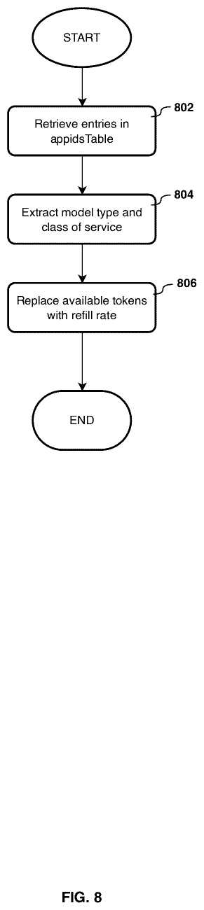

FIG. 8 illustrates example of logic for refilling quotas. Operations may start on a schedule, such as every minute. For example, the token bucket refiller 214 may be executed every minute.

Entries in the appidsTable for all of the app identifiers 302 may be retrieved 802. Every combination of model type and class of service may be extracted 804 from the entries. The available tokens, such as the value in the availableTokens field, may be replaced 806 with the token refill rate, for example, the value in the refillRate field. These fields may be seen in the example appidsTable entries in FIGS. 4A-4C and 5.

In other examples, a more precise and aggressive refill strategy may be employed. For example, instead of simply replacing 806 the available tokens with the token refill rate, the refillRate may be added to availableTokens. This may reduce future period consumption rates if a prior period has gone into negative quota. In some examples, there are no ‘rollover tokens’ between one-minute intervals, meaning that available Tokens may not exceed the refillRate.

### Route Creation and Selection

A core capability of the AI gateway 100 is its ability to distribute requests across a pool of resources that have the same or similar capabilities. This distribution may be done proportionally to the capacity of each resource, which in the case of AI services may be primarily measured in Tokens Per Minute or any other unit of time. This enables the clients 104 to request a type of underlying provider, for example, gpt-35-16k-pgo-amrs, without necessarily needing their own deployment of that provider type. The AI gateway 100 may handle this request distribution by maintaining a set of routes that map the client requested service to a set of underlying providers 108.

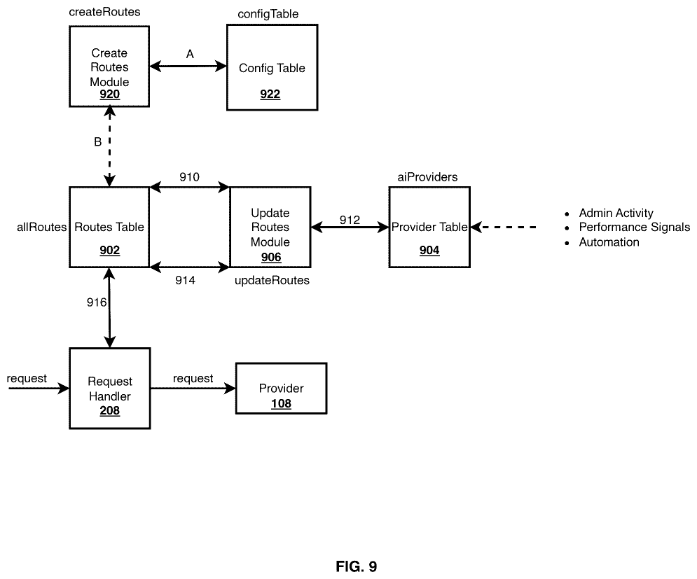

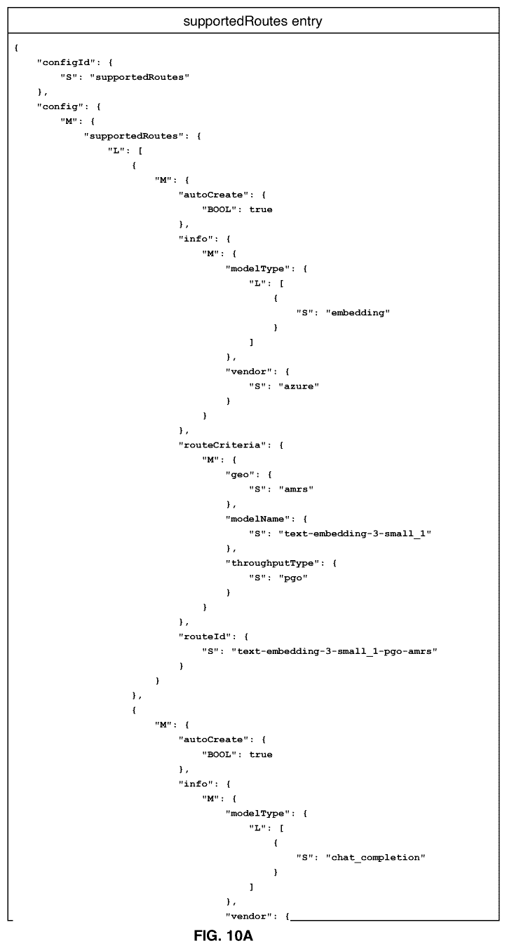

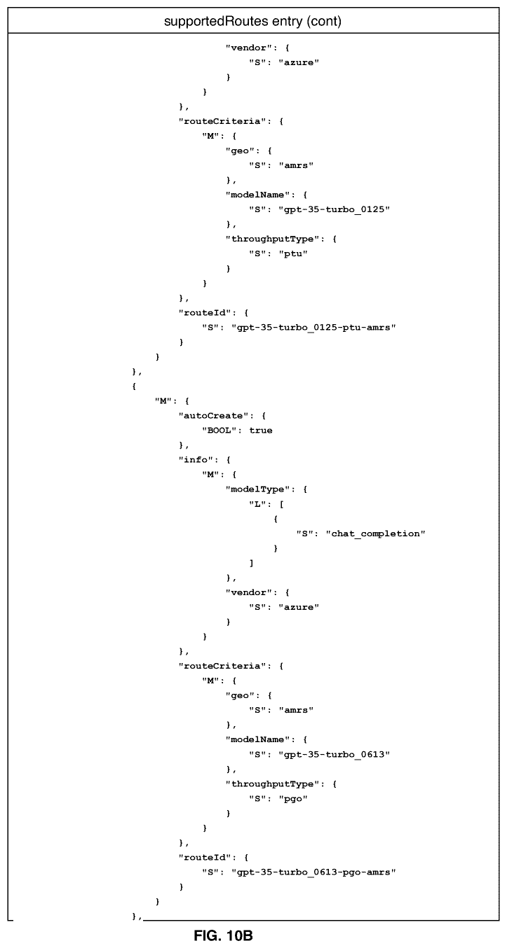

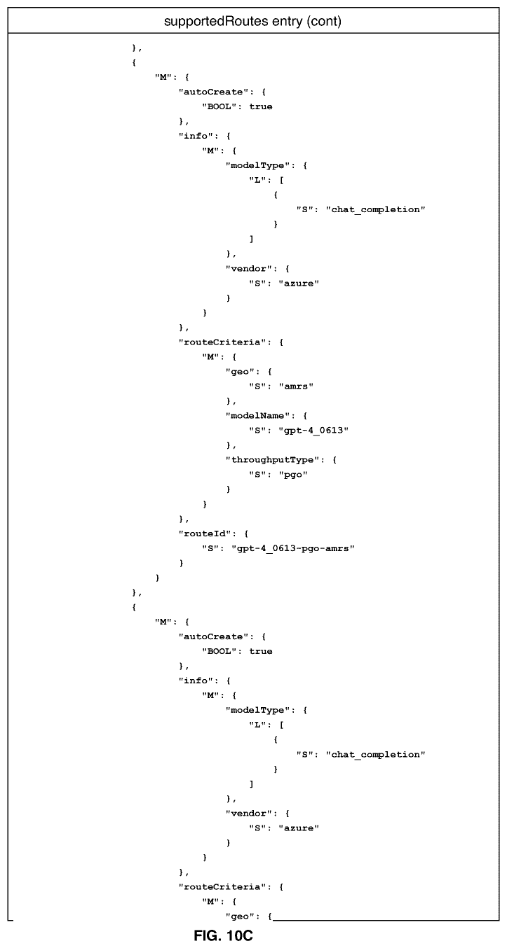

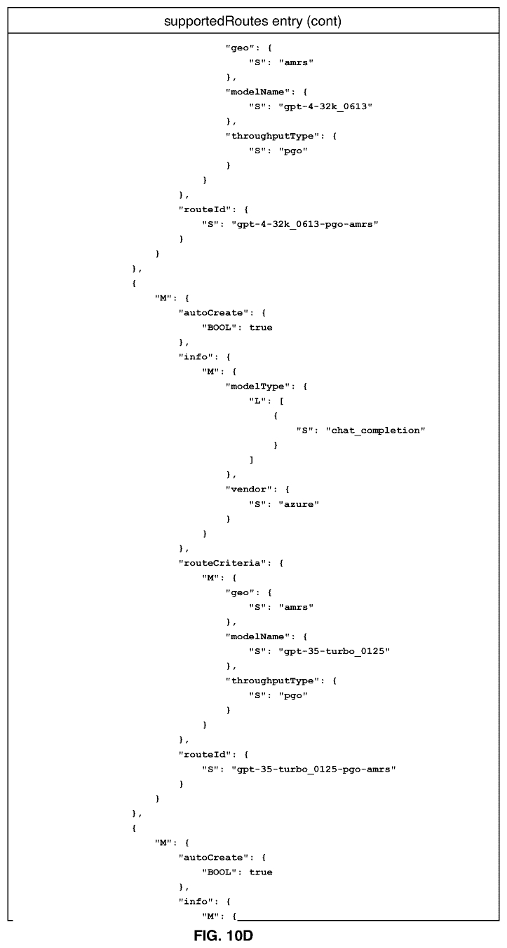

FIG. 9 is a flow diagram of example logic for creating and selecting routes for the AI service 202 or 204.

Request routing for the AI services 202 and 204 may be driven by a table of routes, also called a routes table 902, (for example, aiRoutes table) and a table of the providers 108, also called a provider table 904, (for example, aiProviders) combined with a background process (for example, an update routes module 906) that dynamically refreshes the route table 902.

A scheduler, such as EventBridge or cron, invokes the update routes module 906 at a regular interval, such as every 10 minutes. The update routes module 906 reads 910 all the routes from the routes table 902. The routes map each AI model, such as “gpt-35-4k-pgo”, to one or more addresses of one or more corresponding AI model deployments 106. The addresses may be URLs, for example.

Based on a routeCriteria for each route, the update routes module 906 finds 912 all matching AI model deployments 106 from the providers table 904. The routeCriteria may specify, for example, a name of an AI model, a throughput type or service type, a geographical location, and/or any other criterium for a route. Examples of routeCriteria include geography, region, vendor, model, capacity, and/or service class.

The update routes module 906 may update 914 each route in the routes table 902 with a list of available providers 108 matching the routeCriteria.

When the request handler 208 receives the AI service request 102 form the client 104, request handler 208 may retrieve 916 routes as needed from the routes table 902. Administrator activity, system signals, and automation may manipulate the items and attributes of items in the provider table 904 and result in refreshing the contents of the provider table 904. An example of an administrative activity may include, for example, introducing a new LLM provider to the AI gateway 100. Examples of the system signal may include online, offline, latency, and tokens processed per interval. Manipulating the items and attributes of items in the provider table 904 may ultimately dictate the attributes of routes in the routes table 902.

A create routes module 920 may execute regularly, such as every 30 minutes, or at some other frequency. The create routes module 920 may extract supported routes from the config table 922. If any of the supported routes do not already exist as a route (label/item) in the routes table 902, the create routes module 920 may add the supported routes to the routes table 902. For safety purposes, routes may not be automatically removed from the routes table 902. However, in some examples, routes may be automatically removed from the routes table 902, such as if the config table 922 indicates the routes are to be removed.

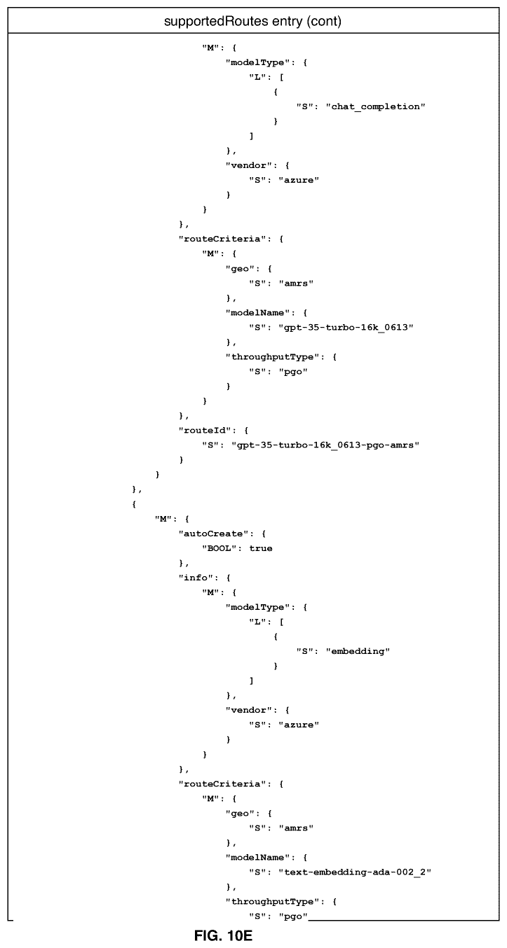

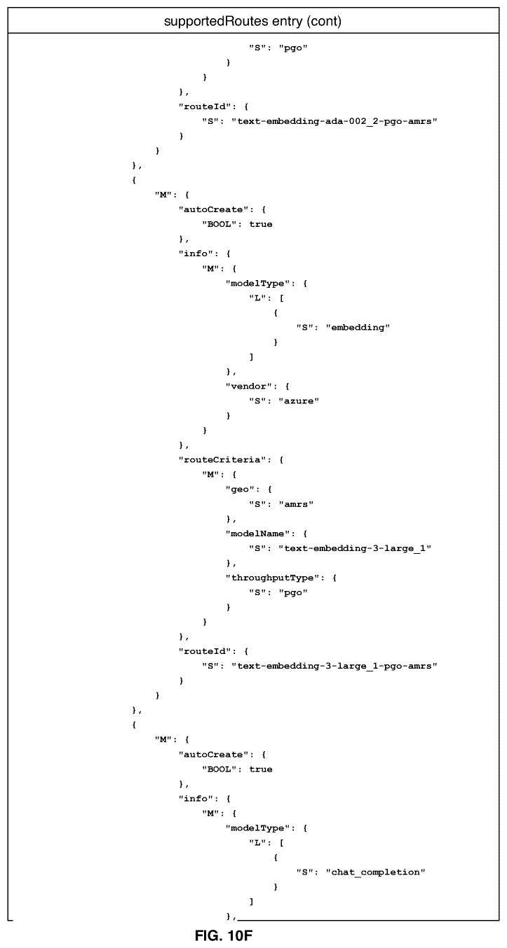

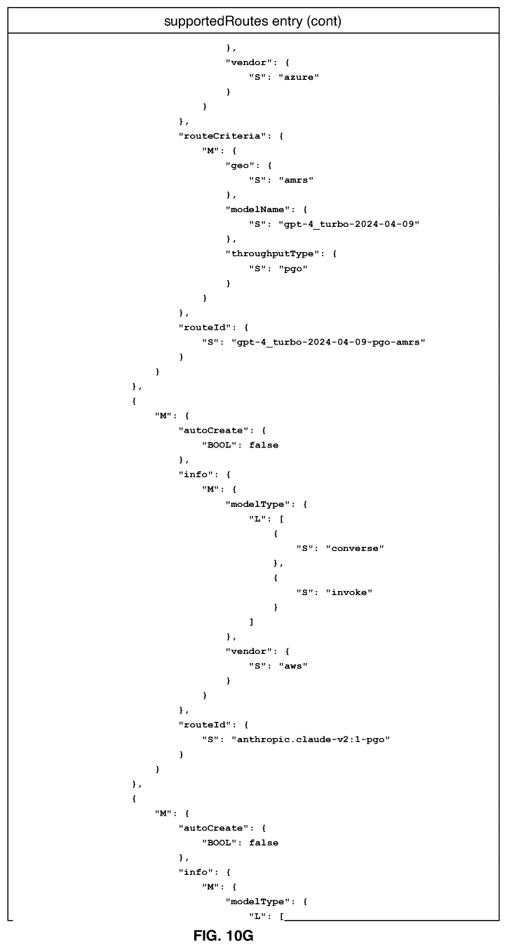

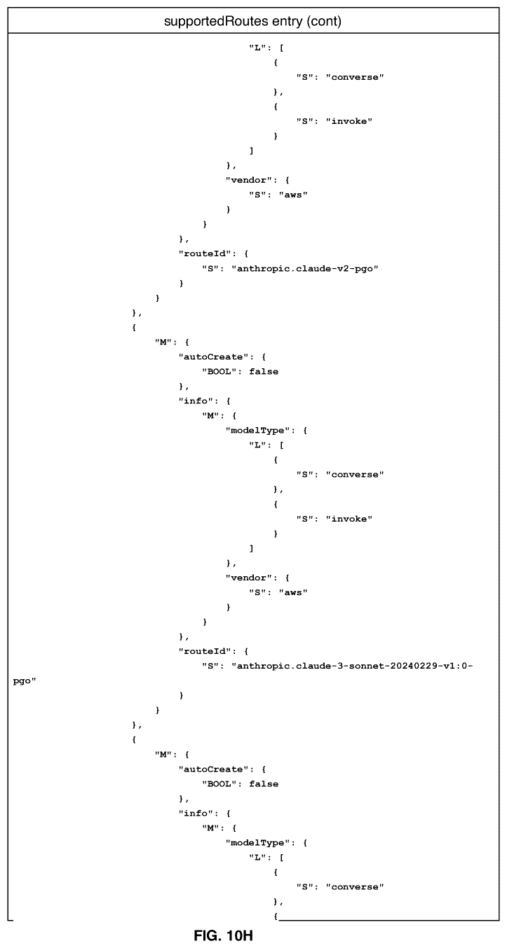

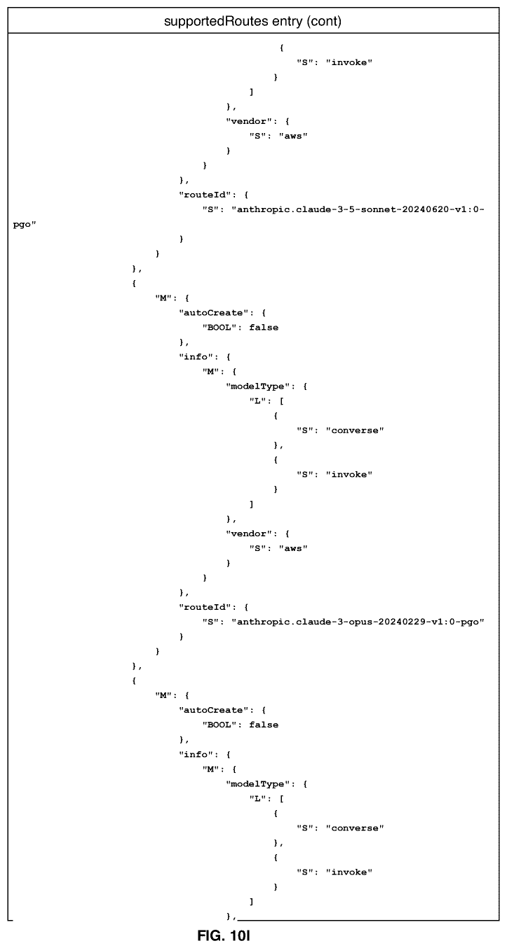

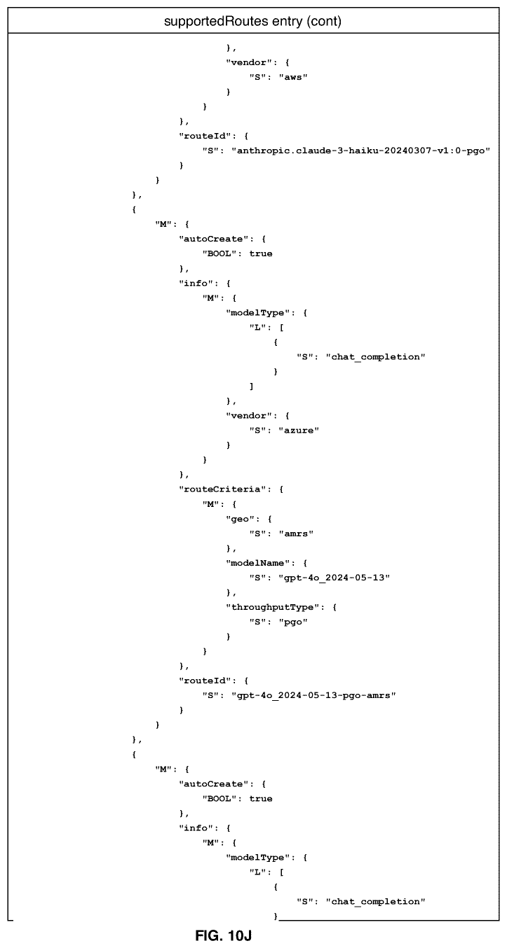

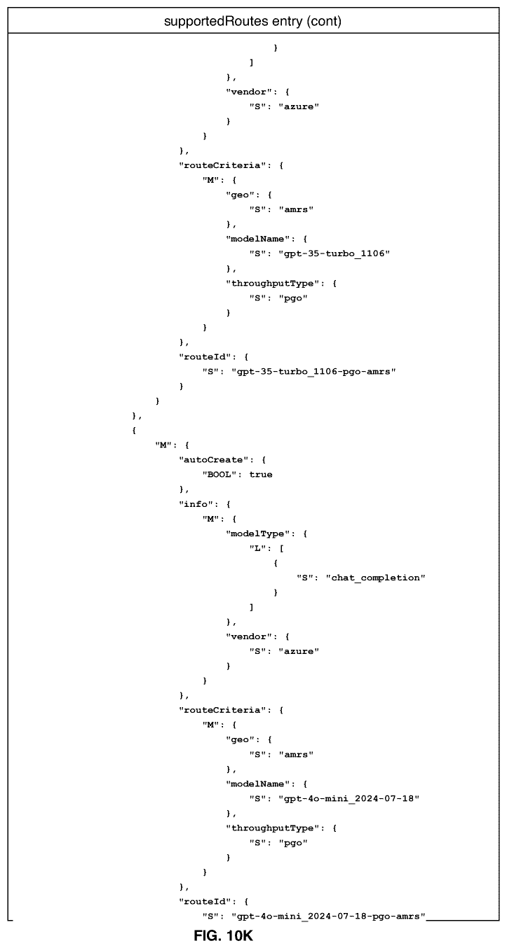

The config table 922 may include one or more supportedRoutes entries. FIGS. 10A-L illustrate an example of a supportedRoutes entry. As described above, the create routes module 920 may extract supported routes from the config table 922. The supported routes may be identified in the supportedRoutes entry or entries.

If any of the supported routes do not already exist as a route (label/item) in the routes table 902, the create routes module 920 may add the supported routes to the routes table 902. In some examples, each route in the routes tables 902 may be identified by a routeId. The routeId may include a triplet comprising a model name, a class of service, and a geographical region (for example, gpt-35-16k-pgo-amrs). In other examples, the routeId may comprise additional, fewer, and/or different components. FIG. 11 illustrates an example route in the routes table 902. A route may contain routeCriteria, which are a set of matching rules that a background process, such as the update routes module 906, may use to dynamically populate the list of providers 108 (AI model deployments 106) in the route from matching entries in the provider table 904. The AI model deployment 106 may be hosted by a third-party or in-house.

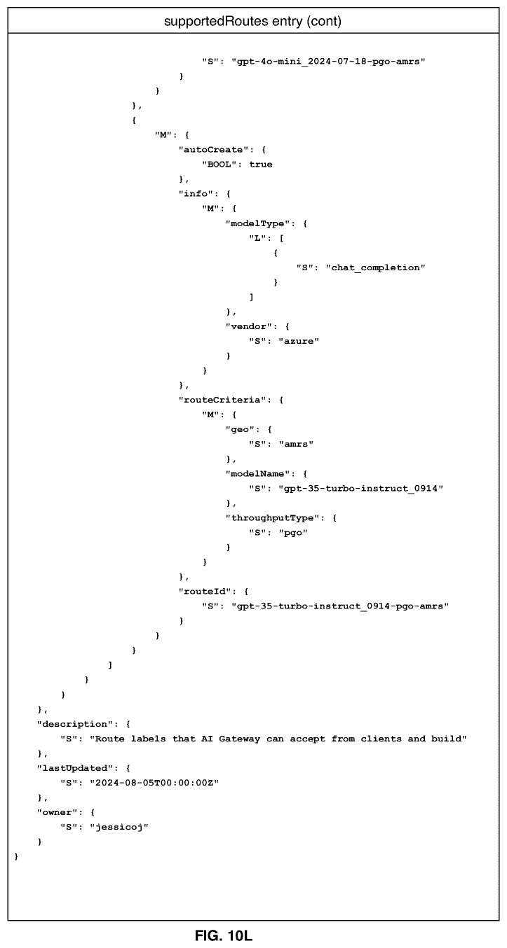

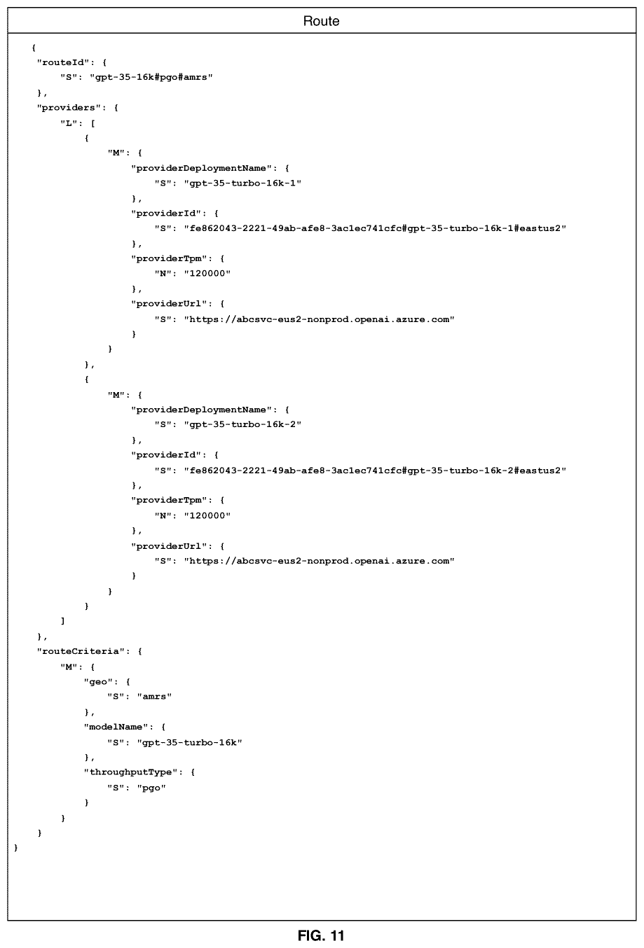

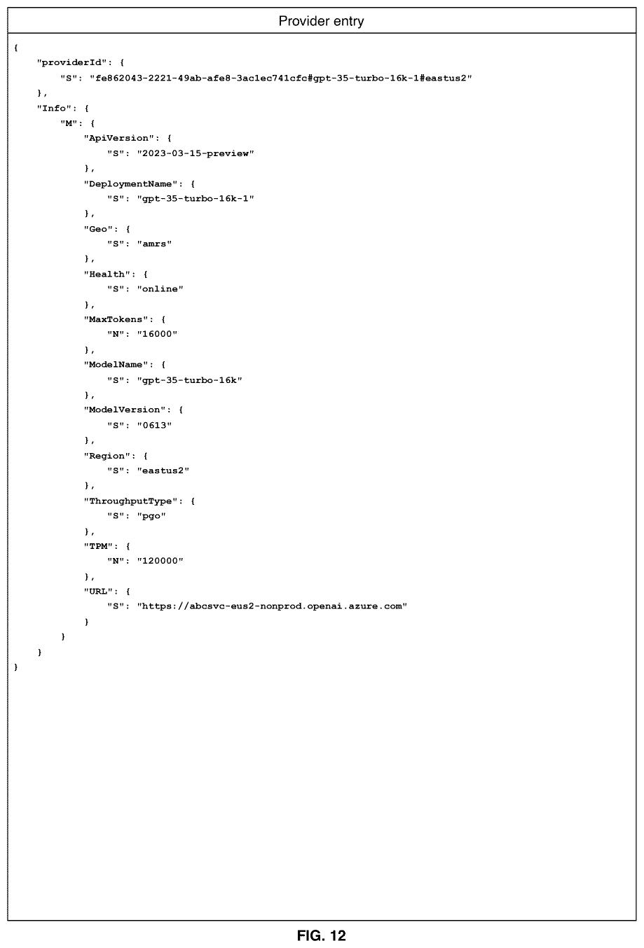

FIG. 12 illustrates an example of a provider entry in the provider table 904. The list of providers 108 in the provider table 904 may include identifiers of AI model deployments 106 that may be available. In the provider table 904, the info attributes of each provider 108 and/or each AI model deployment 106 may be evaluated by the update routes module 906 to find eligible providers and AI model deployments 106. For example, only AI model deployments 106 having a health of “online” may be considered eligible. In some examples, the health attribute may be overloaded with context about why any of the AI model deployments 106 should not be used. For example, the health attribute may be offline_new if a deployment has just been built and not tested or offline_maintenance if there is known work affecting availability. The update routes module 906 may add and/or update the routes table 902 with the eligible AI model deployments 106.

### Route Selection

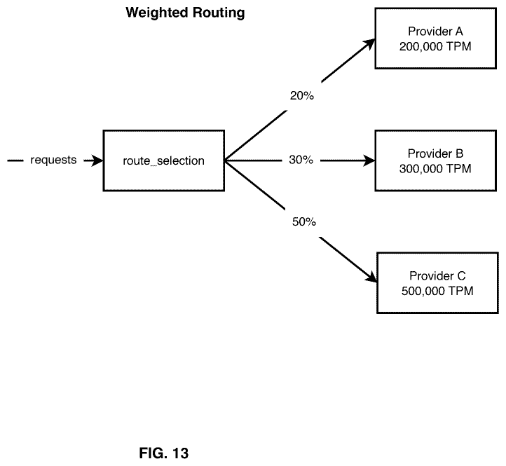

The AI gateway 100 may route the AI service requests 102 using any desired routing logic. FIG. 13 illustrates an example of weighted routing. With weighted routing, the AI gateway 100 may route the AI service request 102 according to weights assigned to the AI model deployments 106. For example, each of the AI model deployments 106 may be assigned a corresponding token per minute (TPM) value, which may be considered a weight for routing purposes. Any other suitable attribute may be used by the AI gateway 100 as a weight for routing purposes. In one such example, a route is selected based on a weighted analysis of the capacity of all available routes. For example, the AI model deployments 106 may express their capacity to handle requests as tokens per time interval or token use rate. Requests may be delivered proportionally to this capacity metric. In one such example, a route may contain three route members capable of processing, respectively, 60,000 tokens per minute, 30,000 tokens per minute, and 10,000 tokens per minute. Based on this particular set of capabilities, 60% may be delivered to the first route member, 30% to the second route member, and 10% to the third route member. Each of the route members are AI model deployments 106.

Referring to FIG. 13, operations may begin with request handler 208 receiving the AI service request 102. The request handler 208 may extract a provider type, such as gpt-35-16k#pgo#amrs, from AI service request 102. In this example, the provider type identifies a model (gpt-35-16k), a service class (pgo), and a geographical region (amrs). In some examples, the provider type may simply specify the model. The request handler 208 may find a route in the routes table 902 that matches the provider type.

The request handler 208 may find the AI model deployments 106 identified in the route as being available. The request handler 208 may select one of the AI model deployments 106 at random, taking into consideration the weights assigned to the AI model deployments 106. In the example shown in FIG. 13, three distinct providers 108 include AI model deployments 106 available for a route. In some examples, information, such as a URL and/or a deployment name, used by the request handler 208 to create a request to the provider 108 may be included in the route to reduce the number of reads from the database 120 when fulfilling the AI service request 102. In the illustrated example, the percentage chance that any one of the AI model deployments 106 is selected corresponds to the weight assigned to the selected AI model deployment 106 divided by the sum of the weights for all of the AI model deployments 106 available for the route.

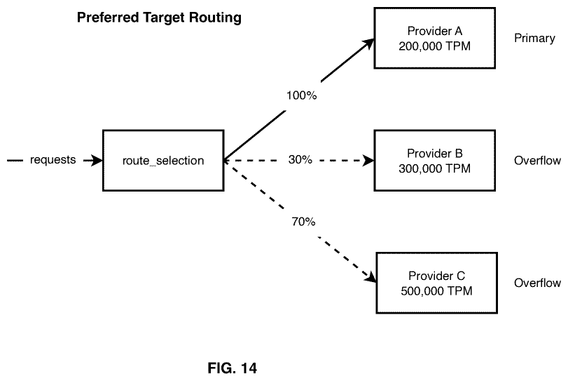

FIG. 14 illustrates an example of preferred target routing. With preferred target routing, the AI gateway 100 may route the AI service requests 102 to one or more preferred AI model deployments 106 until their resources are consumed, at which point, subsequent AI service requests 102 may be routed to supplementary AI model deployments 106. If there are multiple supplementary AI model deployments, the subsequent AI service requests 102 may be routed on, for example, a weighted routing basis.

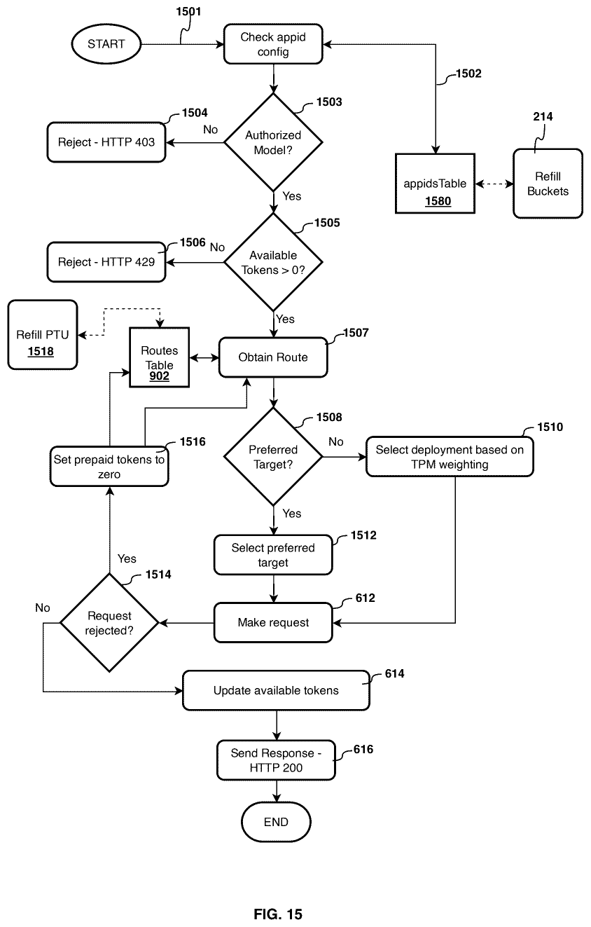

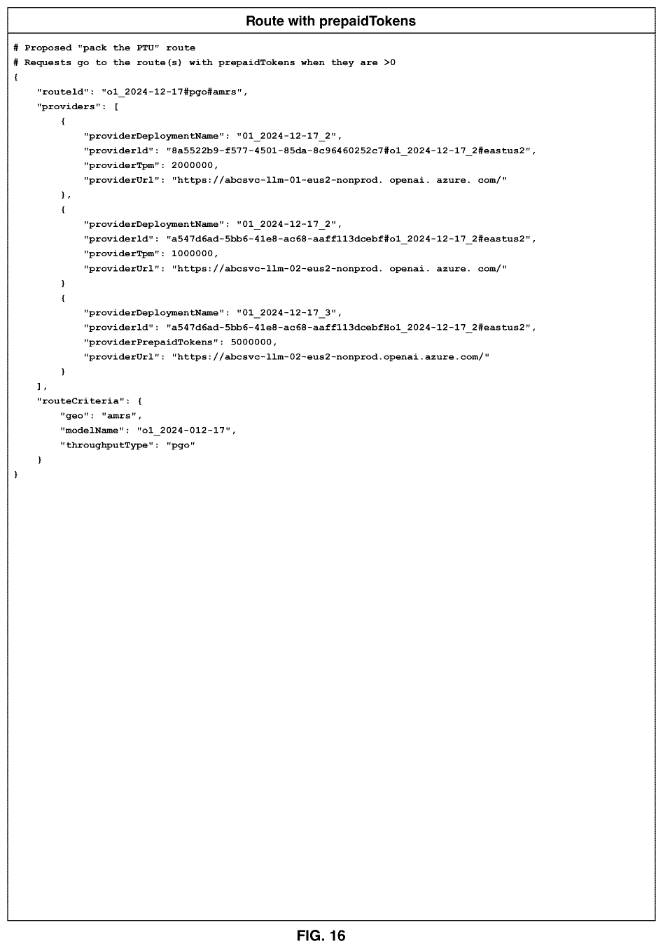

FIG. 15 is a flow diagram of example logic for preferred target routing using a permissive enforcement of the quota system. FIG. 16 illustrates an example of route in which one of the AI model deployments 106 has prepaid tokens, which may be considered a preferred target for any AI service request 102. The preferred target may be selected over the other AI model deployments 106. Prepaid tokens in this context refers generally to pre-provisioned or pre-allocated tokens and does not require the tokens to be purchased.

Referring to FIG. 15, operations may proceed as follows:

The AI service request 102 is received 1501 and the configuration of the app identifier 302 (for example, appid) is fetched 1502 from an appidsTable 1580 in the database 120. The configuration of the app identifier 302 may include entitlements and the number of available tokens.

As described further above, the configuration may be checked 1503 to see if the model is authorized for the app identifier 302. If the model is not authorized, the AI service request 102 may be rejected 1504, for example, by returning an HTTP 403 error. Alternatively, if authorized, operations may proceed to check 1505 if the number of the available tokens are less than zero.

If the number of the available tokens for the model is less than zero, then the AI service request 102 may be rejected 1506, for example, by returning an HTTP 429 “too many requests” error. Alternatively, the route may be obtained 1507 in the routes table 902 that matches the provider type specified in the AI service request 102 as described further above. The set of available AI model deployments 106 for the provider type are identified in the route in the illustrated examples.

First, to select one of the AI model deployments 106 from the set of available AI model deployments 106, the available AI model deployments 106 may be checked 1508 for any preferred targets. In the illustrated example, a preferred target may be any of the available AI model deployments 106 that has a positive number of prepaid tokens. In the example route shown in FIG. 16, the AI model deployment 106 named “01_2024-12-17_3” has a providerPrepaidToken attribute of 5000000. Therefore, the AI model deployment 106 named “01_2024-12-17_3” may be considered the preferred target.

In some examples, such as the one in FIG. 16, the preferred target is a packed PTU. The AI model deployment 106 may be considered a packed PTU deployment if the AI model deployment 106 has a positive number of prepaid tokens, is a PTU class of service, and at least one other of the available model deployments 106 is a PGO class of service.

Case where a Preferred Target is not in the Route

One of the available AI model deployments 106 may be selected 1510 based on, for example, TPM weighting as described further above. The request may be made 612 to the selected AI model deployment 106.

After the request has been processed by the provider 108, the available tokens may be updated 614. For example, the total tokens of consumption may be extracted from the response received from the provider 108, and the token bucket for the app identifier 302 for the selected AI model deployment 106 is reduced by the token consumption quantity.

Operations may end by, for example, returning 616 the response from provider 108 to the client 104.

Case where a Preferred Target is in the Route

If there is a preferred target in the available AI model deployments 106 for the route when checked 1508, then the preferred target may be selected 1512 as the AI model deployment 106. The request may be made 612 to the selected AI model deployment 106.

If the request has been processed by the provider 108, then the available tokens may be updated 614. For example, the total tokens of consumption may be extracted from the response received from the provider 108, and the number of prepaid tokens for the selected AI model deployment 106 (the preferred target) may be reduced by the token consumption quantity. In addition, the token bucket for the app identifier 302 for the selected AI model deployment 106 may be reduced by the token consumption quantity.

Alternatively, the provider 108 may reject 1514 the request because the selected AI model deployment 106 is unavailable for any reason including having exhausted the capacity of the selected AI model deployment 106 indicated by, for example, the prepaid tokens being less than or equal to zero. For example, the provider 108 may return an HTTP 429 “Too many requests” error. This case should be rare if aggressive enforcement of quotas is implemented, and the estimate of the token usage is accurate or sufficiently large.

If the provider 108 rejects 1514 the request because the selected AI model deployment 106 is unavailable, then the prepaid tokens for the selected AI model deployment 106 may be set 1516 to zero. Route selection may start again by, for example, obtaining 1507 the route from the routes table 902, but this time the AI model deployment 106 having the prepaid tokens will not be chosen because the number of prepaid tokens is zero.

As explained above, the token bucket refiller 214 may regularly refill the token bucket in the database 120 for the identities configured in the database 120. The rate at a which the token bucket refiller 214 refills the token bucket may depend on the configuration of the provider and/or service.

In addition, a PTU refiller 1518 may also run as a background process. The PTU refiller 1518 may regularly update the prepaid tokens for PTU deployments identified in the route table 902. For example, the PTU refiller 1518 may execute every minute, at any other frequency, or on any other schedule that enables the PTU refiller 1518 to keep the prepaid tokens for PTU deployments updated in an a timely manner. The prepaid tokens for each respective one of the PTU deployments may be updated to a value estimated to be the number of PTUs per unit of time that the respective one of the PTU deployments may handle.

Without session affinity, the AI gateway 100 may route each AI service request 102 independently from a previous AI service request 102 by the client 104. For example, if Client A makes a request and is routed to Deployment 1, then a subsequent request by Client A is not guaranteed to also be routed to Deployment 1. Alternatively, the AI gateway 100 may implement session affinity by, for example, giving preference to a session identifier included in the AI service request 102 in the routing algorithm.

### Normalization of LLM KPIs for Observability

The AI gateway 100 may extract and normalize information about the AI service requests 102 that the AI gateway 100 proxies and delivers that normalized information to a unified metadata bus. This unified view enables the AI gateway 100 to update its own routing and/or inform downstream customers about who, when, and how the AI model deployments 106 and/or the providers 108 are being used.

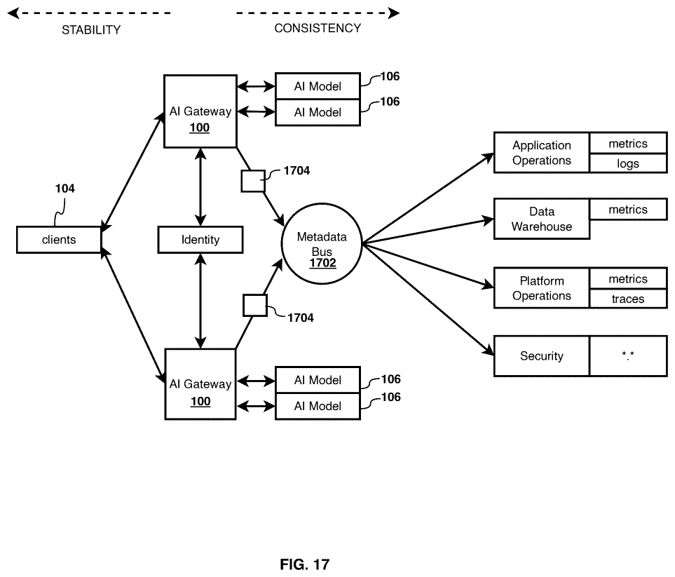

FIG. 17 illustrates an example architecture for the AI gateway 100 that includes a metadata bus 1702 for normalizing Large Language Model Key Performance Indicators (LLM KPIs) or more generally, performance data 1704, for observability purposes. Examples of KPIs may include response time, input token consumption, output token consumption, total token consumption, model region, cache hit status, and consuming identity.

Information that is captured or created and presented in a standard format on the metadata bus 1702 may include one or more of the following: provider, geographic region, input tokens, output tokens, request duration, request type (LLM operation), identity of the client 104, remaining tokens per provider, remaining requests per provider, and results from scans by the AI security module 210 enforcing input and/or output guardrails. Selecting a standard format may help address differences across the providers 108. For example, some providers describe input tokens as “prompt tokens” while others describe them as “input tokens.” More generally, normalizing the performance data 1704 may include grouping data from a first one of the AI model deployments 106 and a second one of the AI model deployments 106 under an attribute name that is different on the first one of the AI model deployments 106 than on the second one of the AI model deployments 106. Alternatively, or in addition, normalizing the performance data 1704 may include grouping data from a first one of the AI model deployments 106 and a second one of the AI model deployments 106 under an attribute name that is different than a corresponding attribute name on both the first one of the AI model deployments 106 and the second one of the AI model deployments 106.

The metadata bus 1702 may be a service that acts as a general-purpose message bus to deliver any piece of the performance data 1704—normalized or not—to any number of message bus subscribers. For example, the token consumption metrics for a single identity may be read by owners of that identity. As another example, consumption metrics for all identities may be read by a centralized billing application. In some examples, input and output token consumption are written in Cloudwatch Embedded Metric Format with the dimensions of appid, the provider 108, and model identifier. In this context, input tokens are the units a model receives as input, such as a prompt or instructions, and output tokens are units the model generates as a response, such as text units.

The monitoring module 1806 may obtain the performance data 1704 from the metadata bus 1702 by, for example, subscribing to the data. The monitoring module 1806 may monitor the data looking for predetermined conditions.

The SLA adherence module 1810 is a specific example of the monitoring module 1806. From the performance data 1704, the SLA adherence module 1810 may determine whether the service level agreements with any of the providers 108 is being met. The SLA adherence module 1810 may send notifications to, for example, an administrator and/or the client 104 if the any of the service level agreements have not been met.

Thus, the AI gateway 100 provides a technical solution to the technical problem of how modules, such as the monitoring module 1806, may obtain and act on the performance data 1704 related to the performance of the AI model deployments 106 and/or the providers 108. Alternatively, or in addition, the AI gateway 100 may provide a technical solution to the technical problem of how modules, such as the monitoring module 1806, may obtain and act on the performance data 1704 when different types of AI model deployments 106 are available through the AI gateway 100.

### Per Client Time Based Access

Time restricted access per entity is an extended feature of authorization. The AI gateway 100 may implement time restricted access per entity by setting a “valid no later than” epoch time for an entire identity (for example, the app identifier 302), for any specific class of service, and/or for any AI model deployment 106. Time restricted access may be further extended to a concept of “valid not before” combined with “valid no later than” to gate access to a specific window of time.

### Synthetic Testing of LLMs

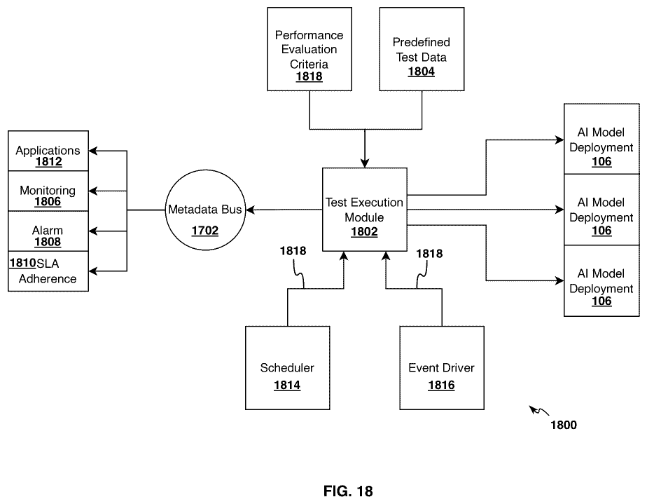

In some examples, the AI gateway 100 provides synthetic testing of LLMs and/or any other type of AI model. FIG. 18 illustrates an example of a system 1800 that provides synthetic testing of the AI model deployments 106. The system 1800 may include a test execution module 1802 and predefined test data 1804. The system 1800 may include a monitoring module 1806, an alarm module 1808, and/or the SLA adherence module 1810 that process results of the synthetic testing. In some examples the system 1800 may include the metadata bus 1702 from which applications 1812, the monitoring module 1806, the alarm module 1808, and/or the SLA adherence module 1810 may obtain the results of the synthetic testing. However, in other examples, the applications 1812, the monitoring module 1806, the alarm module 1808, and/or the SLA adherence module 1810 may obtain the results of the synthetic testing using alternative methods, such as by reading the results from a database, such as from the database 120 used by the AI gateway 100. In some examples, to process the results of the synthetic testing, the monitoring module 1806, the alarm module 1808, and/or the SLA adherence module 1810 may compare the results of the synthetic test to the performance evaluation criteria 1918. The system 1800 may include a scheduler 1814 and an event driver 1816.

Synthetic testing of the AI model deployments 106 may involve one or more of the following: predefined events that trigger tests, the predefined test data 1804 (input data), a set of the AI model deployments 106 (in other words, AI services) to be tested, a standard format of test results, a set of performance evaluation criteria 1918, and a message bus, such as the metadata bus 1702.

During operation of the synthetic testing system 1800, the test execution module 1802 may initiate a synthetic test in response to an indication by the scheduler 1814 based on a schedule. Alternatively, or in addition, the test execution module 1802 may initiate a synthetic test in response to an indication 1818 by the event driver 1816 due to a triggering event.

The indication 1818 may inform the test execution module 1802 to perform a test. For example, the test execution module 1802 may be implemented on a serverless compute service, such as AWS Lambda. The indication 1818 may comprise the scheduler 1814 and/or the event driver 1816 invoking the test execution module 1802. In some examples, the indication 1818 may identify a set of the AI model deployments 106 to execute and/or identify a set of one or more tests to execute.

In response to the indication 1818, the test execution module 1802 may read the predefined test data 1804 from storage, such as from the database 120, and execute one or more tests. The predefined test data 1804 may be well-known test data. In this context, “well-known” means well-known to the AI gateway 100. The well-known test data may or may not be well-known to the world at large. For example, the predefined test data 1804 may include an AI model prompt that takes a substantially fixed amount of time to complete by a given model hosted by a given vendor which is experiencing a given load. Consequently, the amount of time that the model hosted by the vendor takes to respond to the AI model prompt is an indicator of the performance of the AI model deployment 106. The test or tests may include sending at least one request that includes the predefined test data 1804 to one or more of the AI model deployments 106. In other words, the result of the synthetic test may include a measurement of time taken by the AI model deployment 106 to service the at least one request. The test execution module 1802 may send the request(s) directly to the AI model deployment 106 and/or via the AI gateway 100 as AI service request(s) 102.

The test execution module 1802 may measure the time taken by the AI model deployment 106 to service the request by, for example: recording a start time when the request is sent to the AI model deployment 106; recording an end time when a response is received from the AI model deployment 106; and setting the measurement of time taken by the AI model deployment 106 to service the request equal to the end time minus the start time. The result of the synthetic test may include the measurement of time and/or a comparison of the measurement of time compared to an expected duration value.

In some examples, the test execution module 1802 may send the request(s) to all of the AI model deployments 106 and the providers 108. Alternatively, the test execution module 1802 may send the request(s) to a subset of the AI model deployments 106 and the providers 108.

The test execution module 1802 may normalize the test result data and deliver the normalized test result data to the metadata bus 1702 and/or write it to storage. Consumers who can make use of the results may receive it from the metadata bus 1702 and/or from storage.

Test results may include, for example, one or more of the following: performance attributes of the request including pass/fail, response codes, and/or overall duration; attributes of the provider including vendor, region, model, and/or service class; and/or aspects of the request including input tokens, output tokens, model used, and/or operation.

Overall, the synthetic testing system 1800 may have the ability to create a multidimensional performance baseline. The baseline enables an operator to inform application troubleshooting work for the clients 104 of the AI gateway 100 who consume the same providers in differing contexts. Alternatively, or in addition, the baseline performance and/or the test results enable the synthetic testing system 1800 and/or the AI gateway 100 to monitor and enforce service level agreements (SLAs) promised by the provider 108.

As another example, the AI gateway 100 may route the AI service request 102 to an available AI model deployment by selecting the available AI model deployment from a set of AI model deployments 106 based on a result of the synthetic test. For example, if the test results indicate performance of one or more of the AI model deployments 106 falls below a threshold performance level, then the AI gateway 100 may stop routing any AI service requests 102 to the underperforming AI model deployment(s) 106 until, for example, the performance returns to at least the threshold performance level. The underperforming AI model deployment(s) 106 may be identified by a completion time of the AI model request exceeding a threshold level. In another example, the AI gateway 100 may select any of the AI model deployments 106 over the the underperforming AI model deployment(s) 106 instead of ceasing to route to the underperforming AI model deployment(s) 106. Alternatively, or in addition, the test execution module 1802 or other module may identity underperforming AI model deployment(s) 106 by comparing the test results to the dynamic or static performance evaluation criteria 1918. The dynamic or static performance evaluation criteria 1918 may be hard-coded, stored in the database 120, and/or stored in some other location.

In yet another example, the AI gateway 100 may select the available AI model deployment from the set of AI model deployments 106 based on results of the synthetic test indicating the available AI model deployment is a better performing AI model deployment than at least one of the other AI model deployments 106 in the set of AI model deployments 106. Alternatively, or in addition, the AI gateway 100 may route the AI service request 102 randomly to one of the AI model deployments 106, where the probability of selecting any respective one of the AI model deployments 106 is proportional to the performance of the respective one of the AI model deployments 106. Again, the performance may be indicated by the results of the synthetic test.

The components of the AI gateway 100 and/or the synthetic testing system 1800 may be implemented in any number of ways. The AI model deployment 106 may be any configured AI service backed by a statistical model. The AI model deployment 106 may be available for real-time use. Alternatively, the AI model deployment 106 may be disabled and/or shutdown. Examples of the AI service may include the OPENAI branded AI service 202, the AMAZON BEDROCK branded AI service 204, an AI assistant, a conversational AI agent, a chatbot, an AI image generator, an LLM as a service, and any other type of service backed by an AI model.

The AI model is or includes a machine learning (ML) model. The ML model may be a statistical model that is pre-trained or trainable on training data to recognize a pattern from input data and/or make a decision based on the input data without human intervention. The ML model may be trained using supervised learning, unsupervised learning, reinforcement learning, or any other type of machine learning. Once trained, the ML model may apply one or more algorithms to relevant input data to achieve a task or output for which the ML model was trained.

The ML model may be any type of suitable model. Examples of the ML model type may include a generative model, a discriminative model, a diffusion model, a variational autoencoder, a transformer model, a large language model (LLM), a foundation model, a deep learning model, and a combination of model types.

The AI security module 210 may be any security logic configured to enforce content or behavior based guardrails on input to and/or output from an AI model. One example of the AI security module 210 includes CALYPSO AI's scan.

The AI service request 102 may be any request for an AI service. The AI service request 102 may include a prompt, such as a text or an image prompt. The AI service request 102 may be for an AI model, meaning that the requested service is to process the prompt with the AI model. The AI service request 102 may be in any format including, for example, an HTTP request. The AI service request 102 may include structured data in predetermined format, such as in a JSON or a CSV format.

The request handler 208 may be configured to receive the AI service request 102. For example, the request handler 208 may be implemented as an HTTPRequestHandler.

The provider 108 may be a legal entity that hosts an AI service. This may be a third party or the entity that is executing the AI gateway 100. Alternatively, in some contexts herein, the provider 108 refers to the AI service 202 and 204 and/or the AI model deployment 106 hosted by the provider 108.

The alarm module 1808 may be any module configured to raise an alarm, such as a signal, indicating a set of alarm conditions have been satisfied. For example, the alarm module 1808 may send an event to EventBridge if the performance of any of the AI model deployments 106 falls below a threshold level.

The database 120 may include a memory, such as the memory that includes the AI gateway 100 or any other memory, with any electronic collection of information stored therein. The information may be organized so that the information may be accessed, managed, and updated. Examples of a database may include a Structured Query Language (SQL) database, a NoSQL database, a graph database, a Relational Database Management System (RDBMS), an object-oriented database, an extensible markup language (XML) database, a file system, memory structures, or any other organization and storage mechanism. The database may use any type of memory and structure, such as a random-access memory (RAM), a read-only memory (ROM), an erasable programmable read-only memory (EPROM), flash memory, optical memory, magnetic (hard-drive or tape) memory or other memory device, database 120 may include one or more databases.

The database 120 may include tables, such as the appidsTable 1580, the config table 922, routes table 902, and the provider table 904. In this context, the tables are a collection of entries having one or more common attributes and are not necessarily tables in a SQL database. For example, the tables may be a collection of documents in a document database and/or a collection of XML files in a file system.

The client 104 may be any device or software that is configured to send AI service requests 102. Examples of the client 104 may include a desktop application, a mobile app, as server application, a background process, a desktop computer, a mobile device, an internet of things device.

The event driver 1816 may be any component configured to detect and/or produce events, where the events may be received by other components. An example of the event driver 1816 includes AMAZON EventBridge event service.

The scheduler 1814 may be any scheduler component, such as EventBridge or cron.

The logic illustrated in the flow diagrams may include additional, different, or fewer operations than illustrated. The operations illustrated may be performed in an order different than illustrated.

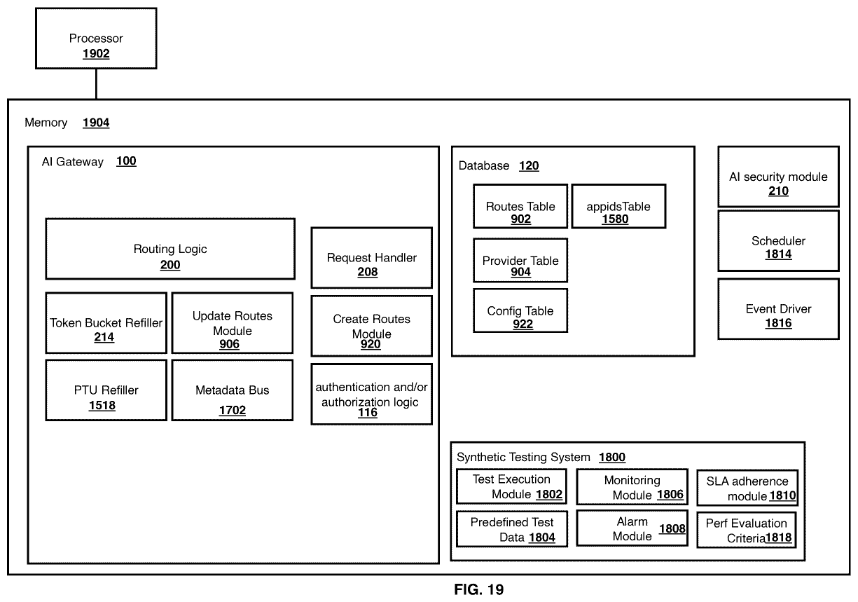

The AI gateway 100 and/or the synthetic testing system 1800 may be implemented with additional, different, or fewer components. For example, in FIG. 19, the AI gateway 100 is included in a memory 1904 which is in communication with a processor 1902. However, in other examples, the AI gateway 100 may include, for example, the processor 1902 and the memory 1904. Each component may include additional, different, or fewer components than illustrated.

The processor 1902 may be in communication with other devices, such as a network interface (not shown) and/or a display (not shown). Examples of the processor 1902 may include a general processor, a central processing unit, a microcontroller, a server, an application specific integrated circuit (ASIC), a digital signal processor, a field programmable gate array (FPGA), and/or a digital circuit, analog circuit.

The processor 1902 may be any device that performs logic operations. The processor 1902 may include a controller, a microcontroller, a general processor, a central processing unit, a graphics processing unit, a server device, an application specific integrated circuit (ASIC), a digital signal processor, a field programmable gate array (FPGA), a digital circuit, an analog circuit, a controller, a microcontroller, any other type of processor, or any combination thereof. The processor 1902 may include one or more elements operable to execute computer executable instructions or computer code embodied in the memory 1904 or in other memory.

The memory 1904 may be any device for storing and retrieving data or any combination thereof. The memory 1904 may include non-volatile and/or volatile memory, such as a random-access memory (RAM or DRAM), solid state memory, flash memory, read-only memory (ROM), erasable programmable read-only memory (EPROM), and/or flash memory. Alternatively, or in addition, the memory 1904 may include an optical, magnetic (hard-drive), or any other form of data storage device.

The AI gateway 100 and/or the synthetic testing system 1800 may be implemented in many different ways. Each module, such as the routing logic 200, the request handler 208, the token bucket refiller 214, the update routes module 906, the create routes module 920, the PTU refiller 1518, the metadata bus 1702, and/or the authentication and/or authorization logic 116, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively, or in addition, each module may include memory hardware, such as a portion of the memory 1904, for example, that comprises instructions executable with the processor 1902 or other processor to implement one or more of the features of the module. When any one of the modules includes the portion of the memory that comprises instructions executable with the processor, the module may or may not include the processor. In some examples, each module may just be the portion of the memory 1904 or other physical memory that comprises instructions executable with the processor 1902 or other processor to implement the features of the corresponding module without the module including any other hardware. Because each module includes at least some hardware even when the included hardware comprises software, each module may be interchangeably referred to as a hardware module, such as the request handler hardware module.

Some features are shown stored in a computer readable storage medium (for example, as logic implemented as computer executable instructions or as data structures in memory). All or part of the system and its logic and data structures may be stored on, distributed across, or read from one or more types of computer readable storage media. Examples of the computer readable storage medium may include a hard disk, a floppy disk, a CD-ROM, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device. However, the computer readable storage medium is not a transitory transmission medium for propagating signals.

The processing capability of the AI gateway 100 and/or the synthetic testing system 1800 may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library.

All of the discussion, regardless of the particular implementation described, is exemplary in nature, rather than limiting. For example, although selected aspects, features, or components of the implementations are depicted as being stored in memories, all or part of the system or systems may be stored on, distributed across, or read from other computer readable storage media, for example, secondary storage devices such as hard disks, flash memory drives, floppy disks, and CD-ROMs. Moreover, the various modules and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network or over telephone lines. In yet other examples, the logic or instructions are stored within a given computer, central processing unit (“CPU”), graphics processing unit (“GPU”), or system.

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same program or apparatus. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action includes setting a Boolean variable to true and the second action is initiated if the Boolean variable is true.

To clarify the use of and to hereby provide notice to the public, the phrases “at least one of <A>, <B>, . . . and <N>” or “at least one of <A>, <B>, . . . or <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

The subject-matter of the disclosure may also relate, among others, to the following aspects:

A first aspect relates to a method comprising: receiving an AI service request for an AI model from a client; and routing the AI service request to an AI model deployment, wherein the routing includes selecting the AI model deployment from a plurality of AI model deployments based on a quality of service.

A second aspect relates to the method of aspect 1, wherein to maintain the quality of service, the AI model deployment is selected based on a token refill rate of the AI model deployments.

A third aspect relates to the method of aspect 2, wherein the AI model deployment is selected at random from the AI model deployments, and a chance of selecting each respective one of the AI model deployments is proportional to the token refill rate of the respective one of the AI model deployments.

A fourth aspect relates to the method of aspect 2, wherein the selecting comprises excluding the AI model deployments having no remaining tokens in a current interval from being selected.

A fifth aspect relates to the method of any preceding aspect, wherein to maintain the quality of service, the AI model deployment is selected over one or more of the AI model deployments because the AI model deployment is assigned provisioned throughput units and the one or more of the AI model deployments are Pay as You Go (PGO).

A sixth aspect relates to the method of aspect 5 further comprising routing a second AI service request to one of the AI model deployments that is Pay as You Go (PGO) in response to a determination that the AI model deployment is unavailable.

A seventh aspect relates to the method of any preceding aspect, wherein the selecting comprises selecting the AI model deployment from the AI model deployments based on the quality of service assigned on a per identity basis to the AI model deployments.

An eighth aspect relates to a computer readable storage medium comprising computer executable instructions, the computer executable instructions executable by a processor, the computer executable instructions comprising: instructions executable by the processor to receive an AI service request for an AI model from a client; and instructions executable by the processor to route the AI service request to an AI model deployment, wherein to route the AI service request, the AI model deployment is selected from a plurality of AI model deployments based on a quality of service.

A ninth aspect relates to the computer readable storage medium of aspect 8 further comprising instructions executable by the processor to extract and normalize information about a plurality of AI service requests and to deliver that normalized information to a metadata bus.

A tenth aspect relates to the computer readable storage medium of any preceding aspect further comprising instructions executable by the processor to send a request that includes predefined test data to a set of the AI model deployments, and to measure a completion time of the request.

An eleventh aspect relates to the computer readable storage medium of aspect 10 further comprising instructions executable by the processor to stop routing any AI service requests to an underperforming AI model deployment in the set of the AI model deployments, wherein the underperforming AI model deployment is identified by the completion time of the AI service request exceeding a threshold level.

A twelfth aspect relates to the computer readable storage medium of any preceding aspect, wherein access to the AI model deployments is controlled on a per identity basis.

A thirteenth aspect relates to the computer readable storage medium of any preceding aspect further comprising instructions executable by the processor to restrict access to the AI model deployments per entity by enforcing a “valid no later than” epoch time for an entire identity.

A fourteenth aspect relates to the computer readable storage medium of any preceding aspect, wherein access to the AI model deployments is controlled on a per identity basis, and wherein an identity corresponds to a bearer token included in the AI service request.

A fifteenth aspect relates to an AI gateway comprising: a processor; and a request handler executable by the processor to receive an AI service request for an AI model from a client and to proxy the AI service request to an AI model deployment, wherein the request handler is executable by the processor to select the AI model deployment from a plurality of AI model deployments based on a quality of service.

A sixteenth aspect relates to the AI gateway of aspect 15 further comprising a token bucket refiller executable by the processor to regularly refill a plurality of token buckets, the token buckets assigned to the AI model deployments, wherein the AI model deployment is selected from the AI model deployments based on the token buckets.

A seventeenth aspect relates to the AI gateway of any preceding aspect further comprising a PTU refiller executable by the processor to regularly update a prepaid tokens setting for any of the AI model deployments that are PTU deployments.

An eighteenth aspect relates to the AI gateway of aspect 17, wherein the request handler is executable by the processor to proxy the AI service request to a preferred target before any other of the AI model deployments, and wherein the preferred target includes any of the AI model deployments that are PTU deployments.

A nineteenth aspect relates to the AI gateway of any preceding aspect, wherein the request handler is executable by the processor to authorize access to AI services based on an identity indicated in the AI service request.

A twentieth aspect relates to the AI gateway of any preceding aspect, wherein the request handler is executable by the processor to enable resource sharing across a plurality of classes of service, wherein the quality of service depends on the classes of services.

A twenty-first aspect relates to a method comprising: performing a synthetic test on at least one of a plurality of AI model deployments; receiving an AI service request for an AI model from a client; and routing the AI service request to an available AI model deployment, wherein the routing includes selecting the available AI model deployment from the AI model deployments based on a result of the synthetic test.

A twenty-second aspect relates to the method of aspect 21, wherein the result of the synthetic test indicates the at least one of the AI model deployments is underperforming, and the available AI model deployment is selected over the at least one of the AI model deployments due to the result of the synthetic test indicating the at least one of the AI model deployments is underperforming.

A twenty-third aspect relates to the method of any of aspects 21 to 22, wherein the result of the synthetic test indicate the available AI model deployment is a better performing AI model deployment than at least one other of the AI model deployments.

A twenty-fourth aspect relates to the method of any of aspects 21 to 23, wherein the at least one of the AI model deployments on which the synthetic test is performed includes the AI model deployments, wherein the available AI model deployment is selected at random from the AI model deployments, and a probability of selecting any respective one of the AI model deployments is proportional to a performance measurement of the respective one of the AI model deployments, and wherein the performance is indicated by the result of the synthetic test.

A twenty-fifth aspect relates to the method of any of aspects 21 to 24 further comprising ceasing to route any additional AI service requests to an underperforming AI model deployment included in the AI model deployments, wherein the underperforming AI model deployment is indicated by the result of the synthetic test.

A twenty-sixth aspect relates to the method of any of aspects 21 to 25, wherein performing the synthetic test comprises sending at least one request that includes predefined test data to the at least one of the AI model deployments and measuring a time taken to service the at least one request.

A twenty-seventh aspect relates to the method of aspect 26, wherein the result of the synthetic test includes the time taken to service the at least one request.

A twenty-eighth aspect relates to a computer readable storage medium comprising computer executable instructions, the computer executable instructions executable by a processor, the computer executable instructions comprising: instructions executable by the processor to perform a synthetic test on at least one of a plurality of AI model deployments; instructions executable by the processor to receive an AI service request for an AI model from a client; and instructions executable by the processor to route the AI service request to an available AI model deployment by selection of the available AI model deployment from the AI model deployments based on a result of the synthetic test.

A twenty-ninth aspect relates to the computer readable storage medium of aspect 28 further comprising instructions executable by the processor to perform the synthetic test on a schedule.

A thirtieth aspect relates to the computer readable storage medium of any of aspects 28 to 29 further comprising instructions executable by the processor to confirm the result of the synthetic test indicates the at least one of the AI model deployments adhere to a threshold performance level.

A thirty-first aspect relates to the computer readable storage medium of any of aspects 28 to 30, wherein the result of the synthetic test indicates the at least one of the AI model deployments is underperforming, and the available AI model deployment is selected over the at least one of the AI model deployments in response to the result of the synthetic test indicating the at least one of the AI model deployments is underperforming.

A thirty-second aspect relates to the computer readable storage medium of any of aspects 28 to 31, wherein the at least one of the AI model deployments on which the synthetic test is performed is included in the AI model deployments, wherein the available AI model deployment is selected at random from the AI model deployments, and a probability of selecting any respective one of the AI model deployments is proportional to the performance of the respective one of the AI model deployments, and wherein the performance is indicated by the result of the synthetic test.

A thirty-third aspect relates to the computer readable storage medium of any of aspects 28 to 32 further comprising instructions executable by the processor to stop routing any AI service requests to an underperforming AI model deployment included in the AI model deployments, wherein the underperforming AI model deployment is indicated by the result of the synthetic test.

A thirty-fourth aspect relates to the computer readable storage medium of any of aspects 28 to 33, wherein the result of the synthetic test includes a time taken for the at least one of AI model deployments to service a request compared with an expected duration.

A thirty-fifth aspect relates to a synthetic testing system comprising: a processor; and a test execution module executable by the processor to perform a synthetic test on at least one of a plurality of AI model deployments, wherein the synthetic test comprises a transmission of a request for an AI model to the at least one of the AI model deployments, the request including an input prompt comprising predefined test data.

A thirty-sixth aspect relates to the synthetic testing system of aspect 35 further comprising an AI gateway, the AI gateway including a request handler executable by the processor to receive an AI service request for an AI model from a client and to proxy the AI service request to an AI model deployment included in the AI model deployments, wherein the request handler is executable by the processor to select the AI model deployment from the AI model deployments based on a result of the synthetic test.

A thirty-seventh aspect relates to the AI gateway of aspect 36, wherein the request handler is executable by the processor to proxy the AI service request to a preferred target before any other of the AI model deployments, and wherein the preferred target includes any of the AI model deployments that are PTU deployments.

A thirty-eighth aspect relates to AI gateway of aspect 37 further comprising a PTU refiller executable by the processor to regularly update a prepaid tokens setting for any of the AI model deployments that are PTU deployments.

A thirty-nineth aspect relates to synthetic testing system of any of the aspects 35 to 38 further comprising a metadata bus, wherein the test execution module is executable by the processor to publish a result of the synthetic test on the metadata bus.

A fortieth aspect relates to synthetic testing system of any of the aspects 35 to 38 further comprising a service level agreement adherence module executable by the processor to perform a comparison of a result of the synthetic test to one or more performance evaluation criteria and to send a notification in response to the comparison indicating a performance level had not been met.

A forty-first aspect relates to a method comprising: receiving an AI service request for an AI model from a client; routing the AI service request to an AI model deployment, wherein the routing includes selecting the AI model deployment from a plurality of AI model deployments based on a quality of service; capturing performance data on the AI model deployments; and delivering the performance data on a metadata bus.

A forty-second aspect relates to the method of aspect 41 further comprising normalizing the performance data that is delivered on the metadata bus.

A forty-third aspect relates to the method of any of aspects 41 to 42, wherein the performance data includes Large Language Model Key Performance Indicators (LLM KPIs) for the AI model deployments.

A forty-fourth aspect relates to the method of aspect 43, wherein the LLM KPIs includes remaining tokens per provider.

A forty-fifth aspect relates to the method of aspect 43, wherein the LLM KPIs includes an indication of input token consumption and/or output token consumption.

A forty-sixth aspect relates to the method of aspect 43, wherein the LLM KPIs includes an indication of remaining tokens per provider and/or remaining requests per provider.

A forty-seventh aspect relates to the method of aspect 42, wherein normalizing the performance data comprises grouping data from a first one of the AI model deployments and a second one of the AI model deployments under an attribute name that is different on the first one of the AI model deployments than on the second one of the AI model deployments.

A forty-eighth aspect relates to a computer readable storage medium comprising computer executable instructions, the computer executable instructions executable by a processor, the computer executable instructions comprising: instructions executable by the processor to receive an AI service request for an AI model from a client; instructions executable by the processor to route the AI service request to an AI model deployment, wherein the routing includes selecting the AI model deployment from a plurality of AI model deployments based on a quality of service; instructions executable by the processor to capture performance data on the AI model deployments; and instructions executable by the processor to store the performance data.

A forty-ninth aspect relates to the computer readable storage medium of aspect 48 further comprising normalizing the performance data that is stored.

A fiftieth aspect relates to the computer readable storage medium of any of aspects 48 to 49, wherein the performance data includes a response time for the AI model deployment to process the AI service request.

A fifty-first aspect relates to the computer readable storage medium of any of aspects 48 to 50, wherein the performance data includes a total token consumption by each of the AI model deployments.

A fifty-second aspect relates to the computer readable storage medium of any of aspects 48 to 51, wherein the performance data includes results from scans by an AI security module configured to enforce input and/or output guardrails.

A fifty-third aspect relates to the computer readable storage medium of any of aspects 48 to 52 further comprising instructions executable by the processor to deliver any piece of the performance data to any number of message bus subscribers.

A fifty-fourth aspect relates to the computer readable storage medium of any of aspects 48 to 53 further comprising instructions executable by the processor to stop routing any AI service requests to an underperforming AI model deployment included in the AI model deployments, wherein the underperforming AI model deployment is identified by a completion time of the AI service request exceeding a threshold level.

A fifty-fifth aspect relates to an AI gateway comprising: a processor; and a request handler executable by the processor to receive an AI service request for an AI model from a client and to proxy the AI service request to an AI model deployment, wherein the request handler is executable by the processor to select the AI model deployment from a plurality of AI model deployments based on a quality of service, wherein the request handler is executable by the processor to capture performance data from a processing of the AI service request by the AI model deployment.

A fifty-sixth aspect relates to the AI gateway of aspect 55, wherein the quality of service depends on a time taken by each of the AI model deployments to service one or more respective AI service requests received by the request handler before the AI service request.

A fifty-seventh aspect relates to the AI gateway of any of aspects 55 to 56, wherein the request handler is executable by the processor to deliver the performance data to a metadata bus.

A fifty-eighth aspect relates to the AI gateway of any of aspects 55 to 57, wherein the request handler is executable by the processor to store the performance data in a database.

A fifty-ninth aspect relates to the AI gateway of any of aspects 55 to 58 further comprising a token bucket refiller executable by the processor to refill a plurality of token buckets at a predetermined rate, the token buckets assigned to the AI model deployments, wherein the AI model deployment is selected from the AI model deployments based on the token buckets.

A sixtieth aspect relates to the AI gateway of any of aspects 55 to 56, wherein the request handler is executable by the processor to proxy the AI service request to a preferred target before any other of the AI model deployments, and wherein the preferred target includes any of the AI model deployments that are PTU deployments.

In addition to the features mentioned in each of the independent aspects enumerated above, some examples may show, alone or in combination, the optional features mentioned in the dependent aspects and/or as disclosed in the description above and shown in the figures.

While various examples have been described, it will be apparent to those of ordinary skill in the art that many more examples and implementations are possible. Accordingly, the examples and implementations described herein are descriptive, but not the only possible examples and implementations.

What is claimed is:

1. A method comprising:
performing a synthetic test on at least one of a plurality of AI model deployments;
receiving an AI service request for an AI model from a client; and
routing the AI service request to an available AI model deployment, wherein the routing includes selecting the available AI model deployment from the AI model deployments based on a result of the synthetic test.

2. The method of claim 1, wherein the result of the synthetic test indicates the at least one of the AI model deployments is underperforming, and the available AI model deployment is selected over the at least one of the AI model deployments due to the result of the synthetic test indicating the at least one of the AI model deployments is underperforming.

3. The method of claim 1, wherein the result of the synthetic test indicate the available AI model deployment is a better performing AI model deployment than at least one other of the AI model deployments.

4. The method of claim 1, wherein the at least one of the AI model deployments on which the synthetic test is performed includes the AI model deployments, wherein the available AI model deployment is selected at random from the AI model deployments, and a probability of selecting any respective one of the AI model deployments is proportional to a performance measurement of the respective one of the AI model deployments, and wherein the performance is indicated by the result of the synthetic test.

5. The method of claim 1 further comprising ceasing to route any additional AI service requests to an underperforming AI model deployment included in the AI model deployments, wherein the underperforming AI model deployment is indicated by the result of the synthetic test.

6. The method of claim 1, wherein performing the synthetic test comprises sending at least one request that includes predefined test data to the at least one of the AI model deployments and measuring a time taken to service the at least one request.

7. The method of claim 6, wherein the result of the synthetic test includes the time taken to service the at least one request.

8. A computer readable storage medium comprising computer executable instructions, the computer executable instructions executable by a processor, the computer executable instructions comprising:
instructions executable by the processor to perform a synthetic test on at least one of a plurality of AI model deployments;
instructions executable by the processor to receive an AI service request for an AI model from a client; and
instructions executable by the processor to route the AI service request to an available AI model deployment by selection of the available AI model deployment from the AI model deployments based on a result of the synthetic test.

9. The computer readable storage medium of claim 8 further comprising instructions executable by the processor to perform the synthetic test on a schedule.

10. The computer readable storage medium of claim 8 further comprising instructions executable by the processor to confirm the result of the synthetic test indicates the at least one of the AI model deployments adhere to a threshold performance level.

11. The computer readable storage medium of claim 8, wherein the result of the synthetic test indicates the at least one of the AI model deployments is underperforming, and the available AI model deployment is selected over the at least one of the AI model deployments in response to the result of the synthetic test indicating the at least one of the AI model deployments is underperforming.

12. The computer readable storage medium of claim 8, wherein the at least one of the AI model deployments on which the synthetic test is performed is included in the AI model deployments, wherein the available AI model deployment is selected at random from the AI model deployments, and a probability of selecting any respective one of the AI model deployments is proportional to the performance of the respective one of the AI model deployments, and wherein the performance is indicated by the result of the synthetic test.

13. The computer readable storage medium of claim 8 further comprising instructions executable by the processor to stop routing any AI service requests to an underperforming AI model deployment included in the AI model deployments, wherein the underperforming AI model deployment is indicated by the result of the synthetic test.

14. The computer readable storage medium of claim 8, wherein the result of the synthetic test includes a time taken for the at least one of AI model deployments to service a request compared with an expected duration.

15. A synthetic testing system comprising:
a processor; and
a test execution module executable by the processor to perform a synthetic test on at least one of a plurality of AI model deployments, wherein the synthetic test comprises a transmission of a request for an AI model to the at least one of the AI model deployments, the request including an input prompt comprising predefined test data.

16. The synthetic testing system of claim 15 further comprising an AI gateway, the AI gateway including a request handler executable by the processor to receive an AI service request for an AI model from a client and to proxy the AI service request to an AI model deployment included in the AI model deployments, wherein the request handler is executable by the processor to select the AI model deployment from the AI model deployments based on a result of the synthetic test.

17. The AI gateway of claim 16, wherein the request handler is executable by the processor to proxy the AI service request to a preferred target before any other of the AI model deployments, and wherein the preferred target includes any of the AI model deployments that are PTU deployments.

18. The AI gateway of claim 17 further comprising a PTU refiller executable by the processor to regularly update a prepaid tokens setting for any of the AI model deployments that are PTU deployments.

19. The synthetic testing system of claim 15 further comprising a metadata bus, wherein the test execution module is executable by the processor to publish a result of the synthetic test on the metadata bus.

20. The synthetic testing system of claim 15 further comprising a service level agreement adherence module executable by the processor to perform a comparison of a result of the synthetic test to one or more performance evaluation criteria and to send a notification in response to the comparison indicating a performance level had not been met.
